(19) United States
(12) Patent Application Publication
(10) Pub. No.: US 2025/0390746 A1
(43) Pub. Date: Dec. 25, 2025

(54) COMPUTER-READABLE STORAGE MEDIUM, METHOD, AND ELECTRONIC DEVICE FOR INFERRING SOFTWARE APPLICATION TO BE EXECUTED USING NEURAL NETWORK

(71) Applicants: Samsung Electronics Co., Ltd., Suwon-si (KR); Seoul National University R&DB Foundation, Seoul (KR)

(72) Inventors: Taieui SONG, Suwon-si (KR); Gahgene GWEON, Seoul (KR)

(21) Appl. No.: 19/307,703

(22) Filed: Aug. 22, 2025

Related U.S. Application Data
(63) Continuation of application No. PCT/KR2024/004868, filed on Apr. 11, 2024.

(30) Foreign Application Priority Data
Apr. 13, 2023 (KR) 10-2023-0049052

(51) Int. Cl. G06N 3/08; G06F 3/04817; G06F 18/2137

(52) U.S. Cl. CPC G06N 3/08; G06F 3/04817; G06F 18/2137

(57) ABSTRACT

Provided is a computer-readable storage medium for storing one or more programs, the one or more programs, when executed by at least one processor of an electronic device, being configured to identify the number of one or more first software applications executed in the electronic device. The one or more programs, when executed by the at least one processor of the electronic device, may be configured to provide, to a neural network in response to the number that has reached a reference number, session information comprising first data representing the one or more first software applications and second data representing time information. The one or more programs, when executed by the at least one processor of the electronic device, may be configured to include instructions for the electronic device to acquire, from the neural network, at least one second software application identified on the basis of the session information.

### CROSS-REFERENCE TO RELATED APPLICATIONS

This application is a continuation application of International Application No. PCT/KR2024/004868 designating the United States and filed on Apr. 11, 2024, in the Korean Intellectual Property Receiving Office and claiming priority to Korean Patent Application No. 0-2023-0049052 filed on Apr. 13, 2023, in the Korean Intellectual Property Office, the disclosures of which are incorporated by reference herein in their entireties.

### TECHNICAL FIELD

Certain example embodiments may relate to a computer-readable storage medium, a method, and/or an electronic device for inferring a software application to be executed using a neural network.

### BACKGROUND ART

Based on a neural network, an electronic device supporting a service capable of interacting with a user is being developed. The electronic device may identify a software application frequently used by the user through the neural network. Based on identifying the frequently used software application, the electronic device may recommend another software application distinct from the software application to the user.

### SUMMARY

In an example non-transitory computer-readable storage medium storing one or more programs, the one or more programs, when executed individually and/or collectively by at least one processor of an electronic device, may be configured to identify a number of at least one first software application executed in the electronic device. The one or more programs, when executed individually and/or collectively by the at least one processor of the electronic device, may be configured to, in response to the number reaching a reference number, obtain a vector parameter based on embedding session information including first data indicating the at least one first software application and second data indicating time information. The one or more programs, when executed individually and/or collectively by the at least one processor of the electronic device, may be configured to provide the obtained vector parameter to a neural network. The one or more programs, when executed individually and/or collectively by the at least one processor of the electronic device, may be configured to obtain at least one second software application identified based on the session information from the neural network.

In an example method performed by an electronic device according to an embodiment, the method may comprise initiating training of a neural network based on identifying a number of at least one first software application executed within the electronic device reaching a reference number. The method may comprise obtaining a vector parameter based on embedding session information including first data indicating the at least one first software application and second data indicating time information. The method may comprise providing the obtained vector parameter to the neural network. The method may comprise training the neural network to identify at least one second software application having a relatively high probability of being executed after the at least one first software application from among a plurality of software applications installed in the electronic device based on the vector parameter.

In an example method performed by an electronic device according to an embodiment, the method may comprise identifying a number of at least one first software application executed in the electronic device. The method may comprise, in response to the number reaching a reference number, obtaining a vector parameter based on embedding session information including first data indicating each of the at least one first software application and second data indicating time information. The method may comprise providing the obtained vector parameter to a neural network. The method may comprise obtaining at least one second software application identified based on the session information from the neural network.

As described above, an electronic device according to an example embodiment may comprise at least one processor, including processing circuitry, and memory including one or more storage media storing instructions. The instructions, when executed by the at least one processor, individually or collectively, may cause the electronic device to identify a number of at least one first software application executed in the electronic device. The instructions, when executed by the at least one processor, individually or collectively, may cause the electronic device to, in response to the number reaching a reference number, obtain a vector parameter based on embedding session information including first data indicating the at least one first software application and second data indicating time information. The instructions, when executed by the at least one processor, individually or collectively, may cause the electronic device to provide the obtained vector parameter to a neural network. The instructions, when executed by the at least one processor, individually or collectively, may cause the electronic device to obtain at least one second software application identified based on the session information from the neural network.

### BRIEF DESCRIPTION OF THE DRAWINGS

FIG. 1 illustrates an example of an operation in which an electronic device displays a software application obtained through a neural network according to an example embodiment.

FIG. 2 illustrates an exemplary block diagram of an electronic device according to an example embodiment.

FIG. 3 illustrates an example of a neural network obtained by an electronic device from a set of parameters stored in memory according to an example embodiment.

FIG. 4 illustrates an example of a flowchart indicating an operation of an electronic device according to an example embodiment.

FIG. 5 illustrates an example of an operation in which an electronic device identifies a software application using session information according to an example embodiment.

FIG. 6 illustrates an example of an operation in which an electronic device identifies another software application based on a use history of software applications, according to an example embodiment.

FIG. 7 illustrates an example of an operation in which an electronic device identifies one or more software applications using session information according to an example embodiment.

FIG. 8 illustrates an example of a flowchart indicating an operation of an electronic device according to an example embodiment.

FIG. 9 illustrates an example of an operation in which an electronic device obtains log information indicating driving of a neural network according to an example embodiment.

FIG. 10 illustrates an example of a flowchart indicating an operation of an electronic device according to an example embodiment.

FIG. 11 illustrates an example of a flowchart indicating an operation of an electronic device according to an example embodiment.

FIG. 12 is a block diagram of an electronic device in a network environment according to various example embodiments.

### DETAILED DESCRIPTION

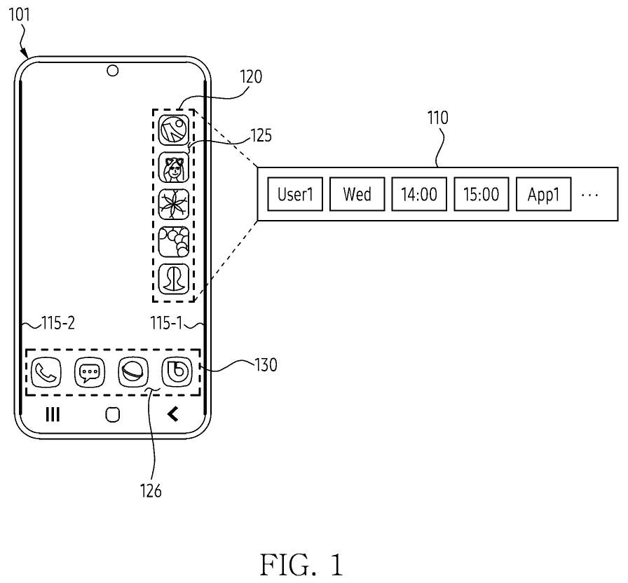

FIG. 1 illustrates an example of an operation in which an electronic device displays a software application obtained through a neural network according to an embodiment. Referring to FIG. 1, an electronic device 101 according to an embodiment may include a personal computer (PC) such as a laptop and a desktop, a smartphone, a smartpad, a tablet PC, and a smart accessory such as a smartwatch and/or a head-mounted device (HMD).

Referring to FIG. 1, an example of a screen displayed on a display of the electronic device 101 is illustrated. The screen may refer to a user interface (UI) displayed in at least a portion of the display. The screen may include, for example, an activity of an Android operating system. In order to display the screen, the electronic device 101 may include hardware such as a display and/or software that provides the screen. In the screen, the electronic device 101 may display one or more visual objects. The visual object may mean an object that may be disposed in the screen for transmission and/or interaction of information, such as an icon, text, an image, a video, a button, a checkbox, a radio button, a text box, a slider and/or a table of a software application. The visual object may be referred to as a visual guide, a visual element, a UI element, a view object, and/or a view element.

Referring to FIG. 1, the electronic device 101 may display at least one first software application 120 among a plurality of software applications on the display using a use history of the plurality of software applications installed in memory. The at least one first software application 120 may be displayed on an edge region 125. The edge region 125 may be obtained based on receiving a swipe input based on a direction from a periphery (e.g., a first periphery 115-1) of the display to another periphery (e.g., a second periphery 115-2). The edge region 125 may include at least a partially curved portion and/or a deformable portion of the display. The edge region 125 may be generated adjacent to the second periphery 115-2 based on a swipe input based on a direction from the second periphery 115-2 toward the first periphery 115-1. However, it is not limited thereto. As an example, independent of receiving a swipe input, displaying the at least one first software application 120 may be maintained on the edge region 125.

For example, the electronic device 101 may identify the at least one first software application 120 to be displayed on the edge region 125 based on session information 110 corresponding to the use history. The session information 110 may include user information of the electronic device 101, time information (e.g., date, time, day of a week), position information indicating a position where the electronic device 101 is positioned, state information indicating a state of the electronic device 101, and/or software application information installed in the electronic device 101. The software application information installed in the electronic device 101 may include software applications executed during a time indicated by the time information. The software application information installed in the electronic device 101 may include an order of the executed software applications. For example, the state information may include a capacity of a battery or whether a communication state is active.

For example, the session information 110 may include information on software applications executed from an unlocked state of the electronic device 101 to a locked state of the electronic device 101. The session information 110 may include information on software applications executed from a state in which execution of the software application is started and/or a screen of the electronic device 101 is turned on to a state in which the screen of the electronic device 101 is turned off. The electronic device may include information on software applications executed for a time set by a user.

The locked state may mean a state in which at least a portion of a plurality of functions usable through the electronic device 101 are disabled. At least another portion of the plurality of functions enabled in the locked state may include an emergency call function, a function of obtaining an image through a camera, and/or a memo function. However, it is not limited thereto. The unlocked state may mean a state in which use of all of the plurality of functions usable through the electronic device 101 is enabled. As an example, the session information 110 may include information on a software application related to execution of at least a portion of the plurality of functions enabled in the locked state. As an example, the session information 110 may include time information including a first timing for identifying the unlocked state and a second timing for displaying the at least one first software application 120. The first timing may include a timing for identifying a state in which the screen of the electronic device 101 is turned on. The first timing may include a timing at which the display of the electronic device 101 enters an enabled state. The second timing may include a timing at which the number of the at least one first software application 120 corresponds to a reference number. The second timing may include a timing for identifying a state (e.g., a doze mode or a standby mode) in which the electronic device 101 is not used for a certain time. However, it is not limited thereto.

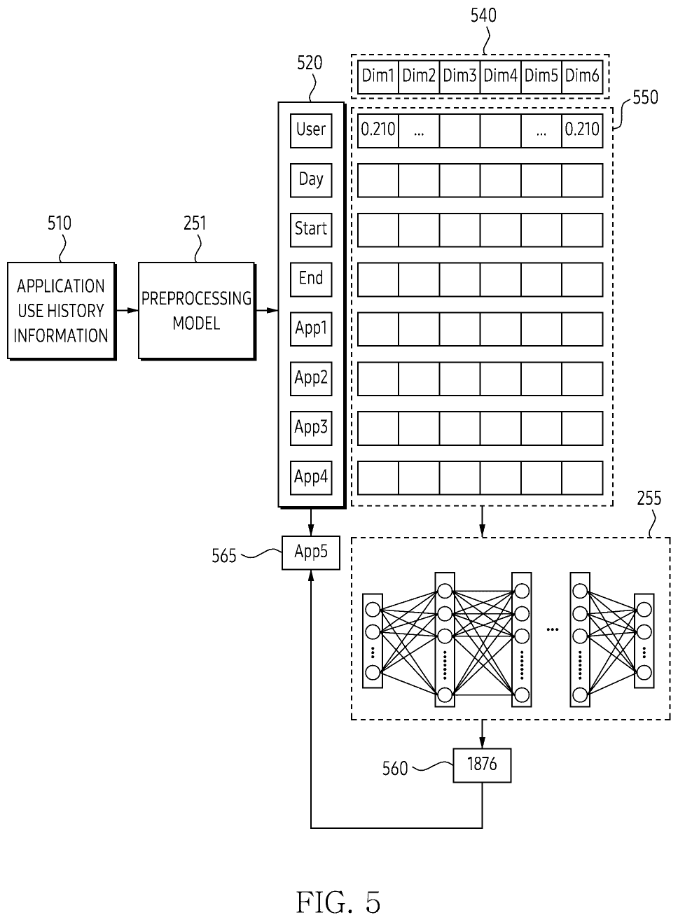

For example, the session information 110 may be obtained through a neural network installed in the electronic device 101. The electronic device 101 may identify the number of software applications executed in the electronic device 101. The electronic device 101 may provide the executed software applications and the session information 110 to the neural network in response to the number of the software applications. The electronic device 101 may infer the at least one first software application 120 using the neural network based on providing the session information 110 to the neural network. An operation in which the electronic device 101 obtains the at least one first software application 120 through the neural network using the session information 110 will be described later in FIG. 5.

For example, the at least one first software application 120 may be an example of software applications inferred to be executed after the executed software applications indicated by the session information 110. The electronic device 101 may display the at least one first software application 120 in the edge region 125 to guide execution of the at least one first software application 120.

For example, the electronic device 101 may display second software applications 130 in a hotseat region 126 of the display independently of displaying the at least one first software application 120 in the edge region 125. The hotseat region 126 may be obtained based on execution of a launcher application for executing a plurality of software applications installed in the electronic device 101. The launcher application may have various forms according to an operating system (e.g., an android operation system (an android OS)) of the electronic device 101. The electronic device 101 may dispose the second software applications 130 that are relatively frequently executed among the plurality of software applications in the hotseat region 126. The electronic device 101 may display the at least one first software application 120 inferred using the session information 110 on the hotseat region 126. In terms of the electronic device 110 being capable of displaying the at least one first software application 120 on the hotseat region 126, the at least one first software application 120 and the second software applications 130 may be substantially similar.

For example, the electronic device 101 may load data for execution of the at least one first software application 120 into a memory region, independently of displaying the at least one first software application 120 on the display. Based on loading the data into the memory region, the electronic device 101 may initiate execution of the at least one first software application 120 more quickly based on receiving an input indicating execution of the at least one first software application 120.

As described above, the electronic device 101 according to an embodiment may display the at least one first software application 120 inferred through the neural network on the edge region 125 and/or the hotseat region 126 by using the session information 110. The at least one first software application 120 may be displayed based on a format such as a pop-up window or a notification message. An operation of displaying the at least one first software application 120 is not limited to the above-described embodiment.

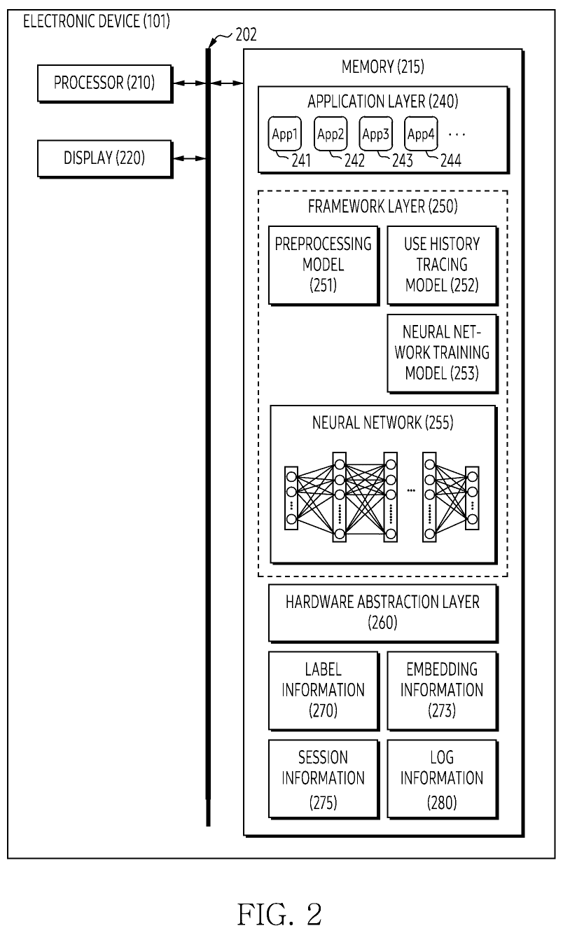

The electronic device 101 may improve accuracy of inference of the at least one first software application to be executed after execution of software applications executed using the session information 110 indicating an execution history of the recently executed software applications. Hereinafter, one or more hardware included in the electronic device 101 and/or at least one software executed based on the one or more hardware will be described with reference to FIG. 2.

FIG. 2 illustrates an exemplary block diagram of an electronic device according to an embodiment. An electronic device 101 of FIG. 2 may include the electronic device 101 of FIG. 1. Referring to FIG. 2, the electronic device 101 according to an embodiment may include a processor 210, memory 215, or a display 220. The processor 210, the memory 215, and the display 220 may be electrically and/or operatively connected to each other by an electronic component (or an electrical component) such as a communication bus 202. Hereinafter, hardware being operatively coupled may mean that a direct connection or an indirect connection between the hardware is established by wire or wirelessly so that second hardware is controlled by first hardware among the hardware. Although illustrated based on different blocks, an embodiment is not limited thereto, and a portion (e.g., at least a portion of the processor 210 and the memory 215) of the hardware of FIG. 2 may be included in a single integrated circuit such as a system on a chip (SoC). A type and/or the number of hardware components included in the electronic device 101 is not limited as illustrated in FIG. 2. For example, the electronic device 101 may include only a portion of hardware components illustrated in FIG. 2.

The processor 210 of the electronic device 101 according to an embodiment may include a hardware component for processing data based on one or more instructions. The hardware component for processing data may include, for example, an arithmetic and logic unit (ALU), a floating point unit (FPU), a field programmable gate array (FPGA), a central processing unit (CPU), and/or an application processor (AP). The number of the processors 210 may be one or more. For example, the processor 210 may have a structure of a multi-core processor such as a dual core, a quad core, or a hexa core.

According to an embodiment, the memory 215 of the electronic device 101 may include hardware for storing data and/or instructions inputted to or outputted from the processor 210. The memory 215 may include, for example, volatile memory such as random-access memory (RAM) and/or non-volatile memory such as read-only memory (ROM). The volatile memory may include, for example, at least one of dynamic RAM (DRAM), static RAM (SRAM), cache RAM, and pseudo SRAM (PSRAM). The non-volatile memory may include, for example, at least one of programmable ROM (PROM), erasable PROM (EPROM), electrically erasable PROM (EEPROM), flash memory, a hard disk, a compact disk, a solid state drive (SSD), and an embedded multi media card (eMMC).

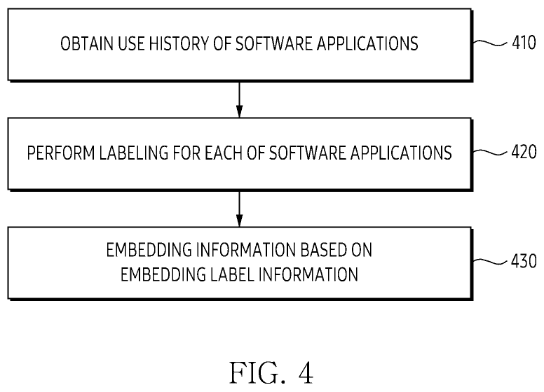

In an embodiment, in the memory 215 of the electronic device 101, one or more instructions (or commands) indicating a calculation and/or an operation to be performed by the processor 210 on data may be stored. A set of the one or more instructions may be referred to as firmware, an operating system, a process, a routine, a sub-routine and/or a software application. For example, the electronic device 101 and/or the processor 210 may perform at least one of operations of FIGS. 4, 8, 10, and/or 11 when a set of a plurality of instructions distributed in a form of an operating system, firmware, a driver, and/or an application is executed.

The display 220 of the electronic device 101 according to an embodiment may output visualized information (e.g., the at least one first software application 120 of FIG. 1) to a user. For example, the display 220 may output an image generated by the processor 210 and/or a graphic processing unit (GPU). The display 220 may include a liquid crystal display (LCD), a plasma display panel (PDP), and/or a plurality of light emitting diodes (LEDs). The LED may include an organic LED (OLED). The display 220 may include a flat panel display (FPD) and/or electronic paper. An embodiment is not limited thereto, and the display 220 may have at least a partially curved shape or a deformable shape.

Referring to FIG. 2, programs installed in the electronic device 101 may be included in any one layer among different layers, including an application layer 240, a framework layer 250, and/or a hardware abstraction layer (HAL) 260, based on a target. For example, programs (e.g., drivers) designed to target hardware (e.g., the display 220) of the electronic device 101 may be included in the hardware abstraction layer 260. For example, programs (e.g., a preprocessing module (preprocessor) 251, a use history tracing module (user history tracer) 252, a neural network training module 253, and/or a neural network 255) designed to target at least one of the hardware abstraction layer 260 and/or the application layer 240 may be included in the framework layer 250. Programs classified into the framework layer 250 may provide an application programming interface (API) that is executable based on another program.

Referring to FIG. 2, a program designed for a user who controls the electronic device 101 may be included in the application layer 240. Referring to FIG. 2, one or more software applications 241, 242, 243, and 244 are exemplified as programs included in the application layer 240, but an attribute and/or the number of the one or more software applications are not limited thereto. For example, programs (e.g., application software) included in the application layer 240 may cause execution of functions supported by programs included in the framework layer 250 by calling the API.

For example, the processor 210 of the electronic device 101 may perform labeling to identify each of executed software applications based on execution of the preprocessing module 251. For example, the processor 210 may obtain a use history and/or an execution order of software applications executed for a specified time based on execution of the use history tracing module 252. The preprocessing module 251 may be referred to as the preprocessor 251.

For example, the processor 210 may perform labeling using session information (e.g., the session information 110 of FIG. 1) including the obtained use history of the software applications and/or information indicating a time based on execution of the use history tracing module 252. Referring to FIG. 1, the use history tracing module 252 and the preprocessing module 251 are illustrated separately, but are not limited thereto. As an example, the preprocessing module 251 may include the use history tracing module 252. The use history tracing module 252 may be referred to as the use history tracer 252.

For example, the processor 210 may perform labeling using user information for identifying the user of the electronic device 101, information on time, and information (e.g., application manifest) of software applications being executed. The processor 210 may obtain label information 270 that may be processed by the processor 210 based on performing labeling user information based on natural language, the information on time, and/or information of software applications. For example, the information on time may include a timing at which execution of software applications executed in the electronic device 101 is initiated, a timing at which the execution is terminated, a timing at which a screen of electronic device 101 is turned on, a timing at which the screen of electronic device 101 is turned off and/or a timing set by the user. However, it is not limited thereto.

As an example, the processor 210 may obtain the label information 270 by using software applications installed in the electronic device 101 as well as information on software applications included in an external server (e.g., a store service capable of installing software applications) through communication circuitry (not illustrated). However, it is not limited thereto.

For example, the processor 210 may obtain the label information 270 based on assigning each of the user information based on natural language, the information on time, and/or the information of software applications to a specified parameter (e.g., a numeric value). For example, the specified parameters may not overlap based on corresponding to different information. The processor 210 may simplify data necessary to infer a software application (e.g., the at least one first software application 120 of FIG. 1) through the neural network 255 based on obtaining the label information 270. As an example, the label information 270 may be indicated as in Table 1.

TABLE 1

| Day of | Start | End | | | | App4(or, |
|---|---|---|---|---|---|---|
| week | time | time | App1 | App2 | App3 | Target app) |
| 100 | 13 | 14 | 1004 | 1005 | 1092 | 1033 |

Referring to Table 1, a day of a week and whether it is a weekend may mean time information (e.g., date information) corresponding to executed software applications. The start time may mean a time (e.g., a start time) at which application 1 (App1) is executed. As an example, the start time may mean a timing at which the at least one first software application is executed by the electronic device 101. The start time may include a timing at which the electronic device 101 identifies an unlocked state. The start time may include a timing at which the electronic device 101 identifies a state in which a screen (e.g., a screen displayed on a display) of the electronic device 101 is turned on. The start time may be a timing set by the user. However, it is not limited thereto. An end time may mean a time at which App3 or App4 is executed. As an example, the end time may mean a time at which the execution of App3 or App4 is terminated. As an example, the end time may mean a timing at which the electronic device 101 identifies a change from the unlocked state to a locked state. The end time may include a timing for identifying a state in which the screen of the electronic device 101 is turned off. The end time may include a timing at which the electronic device 101 identifies a state (e.g., a doze mode or a standby mode) in which the electronic device 101 is not used for a certain time. The end time may be a time set by the user of the electronic device 101. The end time may include a timing at which the execution of App4 is terminated. However, it is not limited thereto.

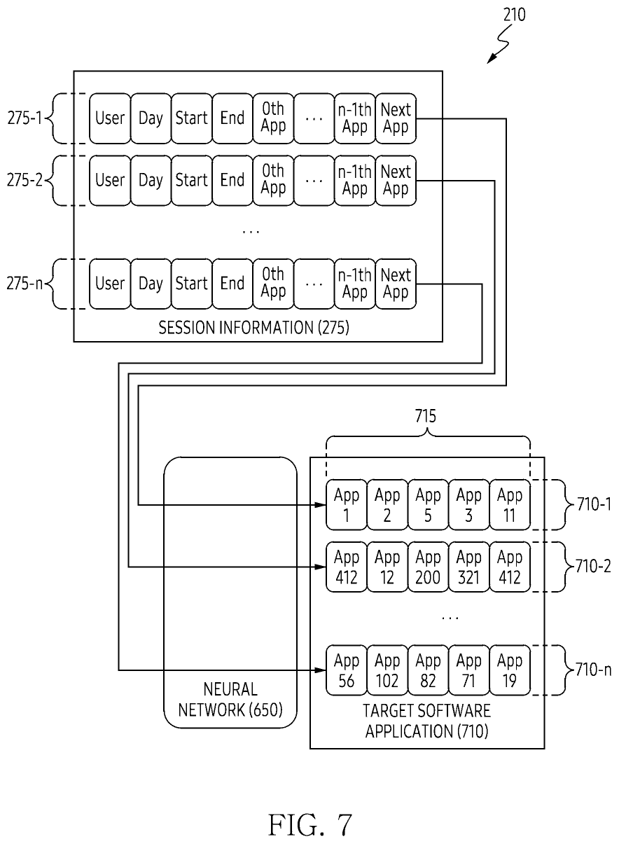

For example, App1, App2, App3, and App4 may be software applications installed in the electronic device 101. App1, App2, App3, and App4 may refer to software applications executed between the start time and the end time. For example, the processor 210 may train the neural network to infer App4 using information included in Table 1. The processor 210 may train the neural network based on supervised learning. For example, the processor 210 may infer that App4 (or a Target app) will be executed after App1, App2, and App3 are executed through the trained neural network, using the information. However, it is not limited thereto. For example, in a case that the processor 210 infers that App4 (or the Target app) will be executed after App1, App2, and App3 are executed through the trained neural network, App4 (or the Target app) may correspond to a target software application 710 of FIG. 7 to be described later.

For example, referring to Table 1, numbers corresponding to each of the day of the week, the start time, the end time, and/or App1 to App4 may be included in label information for identifying each of the day of the week, the start time, the end time, and/or App1 to App4.

For example, the processor 210 may perform embedding to obtain data through the neural network 255 (or the neural network trainer 253) using the label information 270 corresponding to session information 275. For example, the processor 210 performing embedding may include performing an operation of changing information configured with natural language or a number into a vector parameter configured with a number. The processor 210 may obtain embedding information 273 based on dimensions greater than or equal to one dimension based on embedding the label information 270. The embedding information 273 may include vector parameters based on dimensions greater than or equal to one dimension indicating a relationship between user information, information on time, and/or information of an executed software application. The neural network training module 253 may be referred to as the neural network trainer 253.

For example, the label information 270 and/or the embedding information 273 may be used to train the neural network 255 through the neural network training module 253 or to infer a software application (e.g., the at least one first software application 120 of FIG. 1) through the trained neural network 255. An operation in which the processor 210 obtains the embedding information 273 will be described later with reference to FIG. 5.

For example, the processor 210 may train the neural network 255 based on execution of the neural network training module 253. The processor 210 may train the neural network 255 to infer at least one software application to be executed after executed software applications indicated by the session information 275 by inputting the session information 275. An operation of training the neural network 255 by the processor 210 may be performed based on supervised learning.

In an embodiment, the neural network 255 may include a set of parameters stored in the memory 215. The neural network 255 is a recognition model implemented with software or hardware that mimics a computational capability of a biological system using a large number of artificial neurons (or nodes). The neural network 255 may perform a human cognitive action or a learning process through artificial neurons. Parameters related to the neural network 255 may indicate, for example, a plurality of nodes included in the neural network and/or a weight assigned to a connection between the plurality of nodes. The neural network may include a plurality of layers inter-coupled by an architecture such as a convolutional neural network (CNN), a recurrent neural network (RNN), softmax, and/or cross entropy. The neural network 255 may include a combination of hardware (e.g., neural processing unit (NPU)) and/or software for driving the neural network. The number of neural networks 255 stored in the memory is not limited to as illustrated in FIG. 2 and sets of parameters corresponding to each of a plurality of neural networks may be stored in the memory 215.

For example, the processor 210 may guide the user to a state in which at least one operation has been performed using the neural network 255. For example, the processor 210 may notify the user of the state using a notification message indicating the state. For example, the processor 210 may store, in the memory 215, log information 280 indicating performance of operations for identifying at least one second software application that is executable after the at least one first software application identified by the session information 275 using the neural network 255. For example, the operations may include an operation of training the neural network 255 to identify the at least one second software application and an operation of identifying the at least one second software application using the trained neural network 255. The processor 210 may notify the user of whether the neural network 255 is driven by using the log information 280. Operations for guiding the user to a state in which at least one operation has been performed using the neural network 255 are not limited to the above-described description.

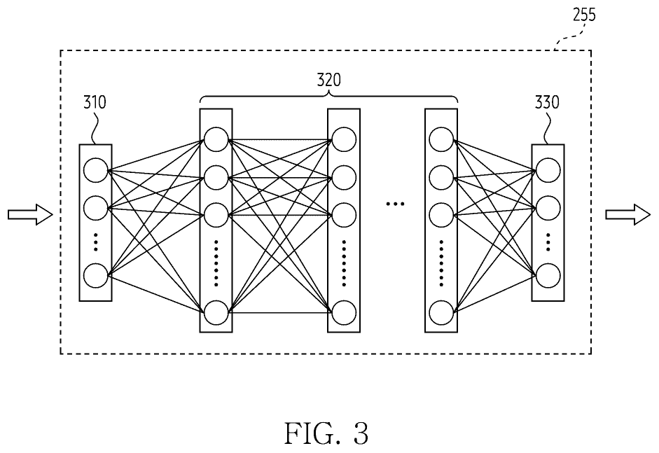

As described above, the electronic device 101 according to an embodiment may train the neural network based on a relatively small amount of computation by using the embedding information 273 based on dimensions greater than or equal to dimension, and infer to identify a software application to be executed by the learned neural network. Hereinafter, in FIG. 3, one or more layers included in the neural network 255 will be described later.

FIG. 3 illustrates an example of a neural network obtained by an electronic device from a set of parameters stored in memory according to an embodiment. Referring to FIG. 3, a set of parameters related to a neural network 255 may be stored in memory (e.g., the memory 215 of FIG. 1) of an electronic device (e.g., the electronic device 101 of FIG. 1) according to an embodiment.

A model trained by a processor (e.g., the processor 210 of FIG. 2) of the electronic device 101 according to an embodiment may be implemented based on the neural network 255 indicated based on a set of a plurality of parameters stored in the memory. Neurons of the neural network 255 corresponding to the model may be divided along a plurality of layers. The neurons may be indicated as a connection line connecting a specific node included in a specific layer and another node included in another layer different from the specific layer and/or as a weight assigned to the connection line. For example, the neural network 255 may include an input layer 310, hidden layers 320, and an output layer 330. The number of hidden layers 320 may be different according to an embodiment.

The input layer 310 may receive a vector (e.g., a vector having elements corresponding to the number of nodes included in the input layer 310) (e.g., the embedding information 273 of FIG. 2) indicating input data (e.g., the label information 270 of FIG. 2). Based on the input data, signals generated from each of nodes in the input layer 310 may be transmitted from the input layer 310 to the hidden layers 320. The output layer 330 may generate output data of the neural network 255 based on one or more signals received from the hidden layers 320. The output data may include, for example, a vector having elements mapped to each of nodes included in the output layer 330.

The hidden layers 320 may be positioned between the input layer 310 and the output layer 330 and may change the input data transmitted through the input layer 310. For example, as the input data received through the input layer 310 propagates sequentially along the hidden layers 320 from the input layer 310, the input data may be gradually changed based on a weight connecting nodes of different layers.

As described above, each of layers (e.g., the input layer 310, the hidden layers 320, and the output layer 330) included in the neural network 255 may include a plurality of nodes. The hidden layers 320 may be a convolution filter fully connected layer in a convolutional neural network (CNN), a softmax layer for multi-class classification, a loss function layer (e.g., cross-entropy) that may check whether the neural network 255 is performed, or various types of filters or layers grouped based on a special function or feature.

A structure in which nodes are connected between different layers is not limited to an example of FIG. 3. In an embodiment, the one or more hidden layers 320 may be layers based on a recurrent neural network (RNN) in which an output value is re-inputted to a hidden layer of a current time. In an embodiment, based on Long Short-Term Memory (LSTM), the neural network 255 may further include one or more gates (and/or filters) for discarding at least one of values of nodes, maintaining them for a relatively long time, or maintaining them for a relatively short time. The neural network 255 according to an embodiment may form a deep neural network by including the plurality of hidden layers 320. Training the deep neural network is called deep learning. A node included in the hidden layers 320 may be referred to as a hidden node.

Nodes included in the input layer 310 and the hidden layers 320 may be connected to each other through a connection line having a weight, and nodes included in the hidden layers 320 and the output layer 330 may also be connected to each other through a connection line having a weight. Tuning and/or training the neural network 255 may mean changing weights between the nodes included in each of the layers (e.g., the input layer 310, the hidden layers 320, and/or the output layer 330) included in the neural network 255. Tuning (or training) of the neural network 255 may be performed, for example, based on supervised learning and/or unsupervised learning.

The electronic device 101 according to an embodiment may train a model 240 based on supervised learning. Supervised learning may mean training the neural network 255 using a set of paired input data and output data. For example, the neural network 255 may be tuned to reduce a difference between the output data outputted from the output layer 330 and the output data included in the set in a state of receiving the input data included in the set. As the number of sets increases, the neural network 255 may generate output data generalized by one or more sets with respect to other input data distinct from the set.

The electronic device 101 according to an embodiment may tune the neural network 255 based on reinforcement learning in unsupervised learning. For example, the electronic device 101 may change policy information used by the neural network 255 to control an agent based on an interaction between the agent and an environment. The electronic device 101 according to an embodiment may cause a change in the policy information by the neural network 255 in order to maximize a goal and/or a reward of the agent by the interaction. The neural network 255 may be trained to obtain an output value, based on identifying an input value.

For example, the electronic device 101 may train the neural network 255 to infer at least one software application to be executed after executed software applications, by inputting session information 275 indicating the executed software applications to the neural network 255. The electronic device 101 may obtain an execution history of software applications corresponding to another number (e.g., 4) less than a reference number based on identifying the number of software applications to be executed corresponding to the reference number (e.g., 5). The electronic device 101 may train the neural network 255 to infer a software application to be executed after the software applications corresponding to the other number (e.g., 4) are executed. After training the neural network 255, in a case that the software applications corresponding to the other number (e.g., 4) are executed, the electronic device 101 may infer the software application to be executed after the software applications corresponding to the other number are executed, using the trained neural network. The inferred software application may be one or more. The electronic device 101 may identify the inferred software application based on obtaining a probability value (e.g., at least one value of 0 to 1) for each of a plurality of software applications installed in the memory (e.g., the memory 215 of FIG. 2) using the trained neural network. For example, the electronic device 101 may display the inferred software application on a display to guide execution of the inferred software application.

FIG. 4 illustrates an example of a flowchart indicating an operation of an electronic device according to an embodiment. The electronic device of FIG. 4 may include the electronic device 101 of FIGS. 1 to 3. At least one of operations of FIG. 4 may be performed by the electronic device 101 of FIG. 2 and/or the processor 210 of FIG. 2. Each of the operations of FIG. 4 may be performed sequentially, but is not necessarily performed sequentially. For example, an order of each of the operations may be changed, and at least two operations may be performed in parallel.

According to an embodiment, in an operation 410, the processor may obtain a use history of software applications. For example, the processor may monitor the software applications executed in the electronic device based on execution of the use history tracing module 252 of FIG. 2. The processor may obtain an order in which each of the executed software applications is loaded into memory of the electronic device. The processor may obtain the use history based on the order in which each of the software applications is loaded into the memory of the electronic device.

According to an embodiment, in an operation 420, the processor may perform labeling for each of the software applications. The processor may perform labeling using a parameter (e.g., numbers) for identifying each of the software applications. The processor may perform labeling using session information (e.g., the session information 275 of FIG. 2) including software applications and time information. The session information may include information on software applications executed during a time period indicated by the time information. For example, the time period may include a timing of identifying a first software application that first execution is initiated based on the order in which each of the software applications is loaded into the memory of the electronic device, and/or a timing of identifying a second software application that execution is terminated (or initiated) last based on the order. As an example, the timing of identifying the second software application may include a timing of inferring a software application to be executed after the software applications executed based on the order.

The processor may obtain the label information 270 by performing labeling using the session information based on execution of the preprocessing module 251 of FIG. 2. As an example, the processor may reduce an amount of data included in the session information based on the preprocessing module, using label information assigned to identify each of software applications.

According to an embodiment, in an operation 430, the processor may obtain embedding information (e.g., the embedding information 273 of FIG. 2) based on embedding the label information. The processor may perform embedding for changing the label information into a vector value based on dimensions greater than or equal to one dimension by inputting the label information to a neural network (e.g., the neural network 255 of FIG. 2). For example, in terms of obtaining a vector parameter based on the processor performing embedding, an operation of performing the embedding may be referred to as an operation of performing vectorization.

The vector value based on the dimensions greater than or equal to one dimension will be described later in FIG. 5.

For example, the processor may train the neural network to infer that other software applications will be executed after software applications included in the embedding information 273 based on the neural network, using the embedding information. The electronic device may train the neural network using the neural network training module 253 of FIG. 2 for training the neural network. For example, the processor may change the label information into the embedding information using the neural network training module.

Hereinafter, in FIG. 5, an example of an operation in which the processor infers the other software application using the embedding information based on the neural network will be described later.

FIG. 5 illustrates an example of an operation in which an electronic device identifies a software application using session information according to an embodiment. An electronic device 101 of FIG. 5 may include the electronic device 101 of FIGS. 1 to 4. A processor 210 of FIG. 5 may be referred to the processor 210 of FIG. 2. Referring to FIG. 5, an example of an operation in which the electronic device 101 (or the processor 210) according to an embodiment performs training to infer at least one software application through a neural network 255 is illustrated.

The processor 210 according to an embodiment may obtain application use history information 510 based on execution of the use history tracing module 252 of FIG. 2. In response to identifying software applications included in a reference number (e.g., 5) using the obtained use history information 510, the processor 210 may identify first data indicating the software applications, second data indicating a timing at which execution of the software applications is initiated, and third data indicating a timing at which execution of a software application executed last among the executed software applications is terminated. For example, the application use history information 510 may include the first data, the second data, and/or the third data. The second data may include the start time described above in Table 1, the third data may include the end time described above in Table 1, and hereinafter, an overlapping description will be omitted.

For example, the processor 210 may obtain one session information including software applications based on identifying the number of the software applications corresponding to the reference number. The processor 210 may obtain session information 520 through a preprocessing module 251 using the application use history information 510. The session information 520 may include user information, time information (e.g., date or time) in which the software applications are executed, and information on the executed software applications. For example, the session information 520 may include labeled data (e.g., the label information 270 of FIG. 2). As an example, the session information 520 may be obtained using a parameter corresponding to each of the user information, the time information, and/or the executed software applications. The session information 520 may include information on the software applications corresponding to the reference number (e.g., 5). The labeled data may include the user information, the time information, and/or numeric information corresponding to each of the executed software applications included in the session information 520.

For example, the processor 210 may obtain embedding information 550 configured with dimensions greater than or equal to one dimension to train the neural network 255 using the session information 520. The processor 210 may obtain the embedding information 550 using the session information 520 through a neural network training module (e.g., the neural network training module 253 of FIG. 2). As an example, the processor 210 may obtain the embedding information 550 using the preprocessing module 251. However, it is not limited thereto.

For example, the embedding information 550 may include the user information, the time information, and/or data sets corresponding to each of the software applications included in the session information 520. The data sets may include parameters based on six dimensions 540. The data sets may be obtained based on at least one algorithm (e.g., word2vec) based on correlation between the information included in the session information 520. As an example, the user information and the time information may be referred to as metadata for inferring a software application using executed software applications.

For example, the processor 210 may obtain information indicating one or more sessions and/or embedding information including one or more embedded data sets based on identifying a use history (e.g., the application use history information 510) of software applications distinguished over time.

For example, the embedding information 550 may include data sets based on the six dimensions 540 based on the correlation between the information included in the session information 520. The embedding information 550 may include parameters (e.g., 0.210 of FIG. 5) corresponding to information (e.g., User) included in the identified session information 520 based on a layer corresponding to each of dimensions (e.g., Dim1 to Dim6) included in the six dimensions 540.

For example, the processor 210 may obtain the data sets based on the six dimensions 540 based on correlation between words based on identifying one text object (e.g., a vowel) included in the words (e.g., User, Day, Start, End, App1 to App4) included in the session information 520.

For example, the processor 210 may train the neural network 255 to infer a fifth software application 565 by inputting the embedding information 550 to the neural network 255. The processor 210 may train the neural network 255 based on supervised learning to infer the fifth software application 565 using the session information 520 including information on a first software application (e.g., App1 of FIG. 5), a second software application (e.g., App2 of FIG. 5), a third software application (e.g., App3 of FIG. 5), a fourth software application (e.g., App4 of FIG. 5), and/or the fifth software application (e.g., App5 of FIG. 5). By training based on supervised learning, the neural network 255 may infer that the fifth software application 565 will be executed after the first software application (e.g., App1 of FIG. 5), the second software application (e.g., App2 of FIG. 5), the third software application (e.g., App4 of FIG. 5), and the fourth software application (e.g., App4 of FIG. 5) are executed based on the time information included in the session information 520. However, it is not limited thereto.

For example, the processor 210 may output labeling data 560 corresponding to the embedding information 550 using the neural network 255. The labeling data 560 corresponding to the embedding information 550 may mean data for identifying the fifth software application 565 to be executed after software applications included in the embedding information 550 are executed based on probability information from the embedding information 550. In other words, the processor 210 may identify the fifth software application 565 corresponding to the labeling data 560 based on identifying the labeling data 560. As an example, the processor 210 may identify the fifth software application 565 from the labeling data 560 using information (e.g., manifest) included in the fifth software application 565.

For example, the processor 210 may store session information and/or embedding information used to train the neural network 255 in the memory. The stored session information and/or embedding information may be used to infer a software application in real time through the learned neural network. As an example, the stored session information and/or embedding information may be used to tune the learned neural network. As an example, the learned neural network may be re-learned using newly obtained session information and/or embedding information after being learned. However, it is not limited thereto.

As described above, the electronic device 101 according to an embodiment may obtain the embedding information 550 based on the dimensions greater than or equal to one dimension using the session information 520 distinguished over time. The electronic device 101 may train the neural network 255 using the embedding information 550 based on the dimensions greater than or equal to one dimension. The electronic device 101 may reduce an amount of calculation for inferring the fifth software application 565 through the neural network 255 based on a relatively small amount of data (e.g., the embedding information 550 based on the dimensions greater than or equal to one dimension). The electronic device 101 may reduce power consumption used to perform at least one function of the electronic device 101 based on reducing the amount of calculation. The electronic device 101 may improve accuracy of an operation of inferring a software application to be executed using a use history of a user as well as reducing the amount of calculation. The electronic device 101 may recommend a software application to be executed to the user more accurately than recommending a software application using algorithms such as most frequently used (MFU) and/or most recently used (MRU).

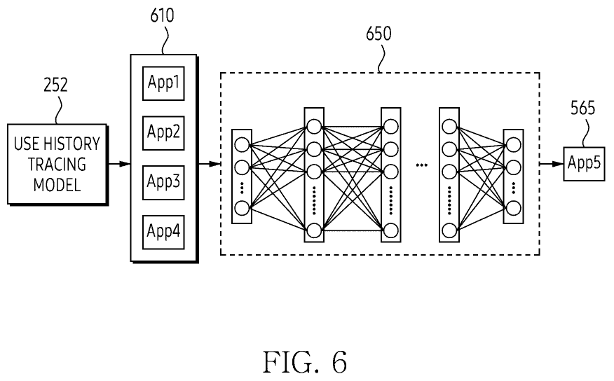

Hereinafter, in FIG. 6, an example of an operation in which the electronic device 101 infers at least one software application using the learned neural network will be described later.

FIG. 6 illustrates an example of an operation in which an electronic device identifies another software application based on a use history of software applications, according to an embodiment. An electronic device 101 of FIG. 6 may include the electronic device 101 of FIGS. 1 to 5. A processor 210 of FIG. 6 may be referred to the processor 210 of FIG. 2. A neural network 650 of FIG. 6 may include a neural network learned to infer at least one software application to be executed through session information. As an example, the neural network 650 may include the neural network 255 of FIG. 2.

Referring to FIG. 6, the processor 210 according to an embodiment may monitor a use history (e.g., the application use history information 510 of FIG. 5) of a software application based on execution of the use history tracing module 252. For example, the processor 210 may identify execution of a first software application (e.g., App1 of FIG. 6) to a fourth software application (e.g., App4 of FIG. 6) after a timing of identifying execution of the first software application. The processor 210 may identify session information 610 including the timing of identifying the execution of the first software application and a timing at which the fourth software application is executed. The session information 610 may include user information and/or time information. The timing of identifying the execution of the first software application may include a timing of identifying a state in which a screen of the electronic device 101 is enabled (e.g., a state in which a display is enabled). The timing of identifying the execution of the first software application may include a timing of entering a specified state (e.g., a doze mode or a standby mode) in a case that the electronic device 101 is not used for a certain time.

For example, the processor 210 may enable the neural network 650 based on identifying execution of at least one of the first software application to the fourth software application. For example, the processor 210 may obtain a fifth software application 565 by inputting the session information 610 to the neural network 650 based on enabling the neural network 650. An operation of the processor 210 inputting the session information 610 to the neural network 650 may include an operation of the processor 210 obtaining label information and/or embedding information corresponding to the session information 610 using the session information 610.

For example, the neural network 650 may output a probability value for each of a plurality of software applications installed in memory using the session information 610. The neural network 650 may infer a software application corresponding to the highest probability value among the outputted probability values as a software application (e.g., the fifth software application 565) to be executed. The number of inferred software applications may be one or more.

For example, the processor 210 may identify a state of the electronic device 101 prior to enabling the neural network 650 using the session information 610. As an example, in a case that the state of the electronic device 101 is a low power mode state, a high temperature state, insufficient usable memory, or an overload state of the processor, the processor 210 may temporarily cease enabling the neural network 650. However, it is not limited to the above-described embodiment.

For example, the processor 210 may identify an external electronic device (not illustrated) corresponding to the fifth software application 565, based on identifying the fifth software application 565. The external electronic device corresponding to the fifth software application 565 may include an electronic device in which the fifth software application 565 is relatively frequently executed.

For example, the processor 210 may obtain session information (e.g., the session information 275 of FIG. 2) from the external electronic device using communication circuitry (not illustrated). The processor 210 may transmit information on the inferred fifth software application 565 to the external electronic device based on execution of software applications corresponding to the session information. However, it is not limited thereto.

Hereinafter, in FIG. 7, an example of an operation in which the electronic device 101 infers at least one software application corresponding to the session information using the probability value for each of the plurality of software applications installed in the memory using the neural network 650 will be described later.

FIG. 7 illustrates an example of an operation in which an electronic device identifies one or more software applications using session information according to an embodiment. An electronic device 101 of FIG. 7 may include the electronic device 101 of FIGS. 1 to 6. A processor 210 of FIG. 7 may be referred to the processor 210 of FIG. 2. Referring to FIG. 7, an example of an operation in which the electronic device 101 according to an embodiment infers a target software application 710 using a neural network 650.

For example, session information 275 may include information on software applications distinguished over time. The session information 275 may include, as an example, information on a type of the electronic device 101 in which the software applications are executed over time.

For example, the processor 210 may obtain the target software application 710 by inputting the session information 275 to the neural network 650. An operation of the processor 210 inputting the session information 275 to the neural network 650 may include an operation of obtaining label information by labeling the session information 275, an operation of obtaining embedding information based on dimensions (e.g., the six dimensions 540 of FIG. 5) greater than or equal to one dimension by embedding the label information and/or an operation of inputting the embedding information to the neural network 650.

For example, the number 715 of the target software applications 710 obtained by the processor 210 may vary. As an example, the electronic device 101 may change the number 715 based on receiving a user input for changing the number 715. However, it is not limited thereto. The processor 210 may obtain an order of each of a plurality of software applications in an order of a high probability value based on the probability value of each of the plurality of software applications identified through the neural network 650, using a first session data set 275-1. The target software application 710 may be an example of software applications corresponding to the number 715 among the plurality of software applications disposed in the order.

For example, the processor 210 may obtain first target software applications 710-1 to nth target software applications 710-n by inputting the first session data set 275-1 to a nth session data set 275-n into the neural network 650. The first session data set 275-1 to the nth session data set 275-n may include user information, time information (e.g., a date, day of a week, a start time, and/or an end time), and information on software applications corresponding to a reference number. For example, Next App of FIG. 7 may mean a software application that is inferred to be executed after software applications (e.g., 0th app to n-1th App of FIG. 7) are executed included in each of the session data sets 275-1 to 275-n. The inferred software application may be obtained through the neural network 650. The inferred software application may be included in the target software application 710.

For example, the processor 210 may obtain data for displaying each of the identified first target software applications 710-1 to nth target software applications 710-n based on identifying each of the first target software applications 710-1 to the nth target software applications 710-n corresponding to each of the session data sets 275-1 to 275-n. The data may be processed by a launcher application. Based on the processor 210 processing the data by the launcher application, at least one target software application displayed on a display among the first target software applications 710-1 to the nth target software applications 710-n may be referred to the at least one first software application 120 of FIG. 1 or the at least one second software application 130 of FIG. 1. However, it is not limited thereto. As an example, the data may be processed by a system process or an activity manager that are distinct from the launcher application.

For example, the processor 210 may load data on at least one of the target software applications 710 into at least one region of memory based on identifying the target software application 710.

For example, an operation of loading data on the at least one into the at least one region of the memory may include an operation in which cache data for executing the at least one occupies the region. The operation of loading data on the at least one into the at least one region of the memory may include an operation of prefetching the at least one. The operation of prefetching the at least one may mean an operation to process execution of the at least one more quickly by loading the data into the at least one region of the memory prior to the execution of the at least one.

For example, the processor 210 may store log information (e.g., the log information 280 of FIG. 2) indicating driving of the neural network 650 in the memory based on obtaining the target software application 710 through the neural network 650. The log information may include enabled information of the neural network 650 after the software applications corresponding to the reference number are executed. The processor 210 may use the log information to notify a user of an enabled state of the neural network 650.

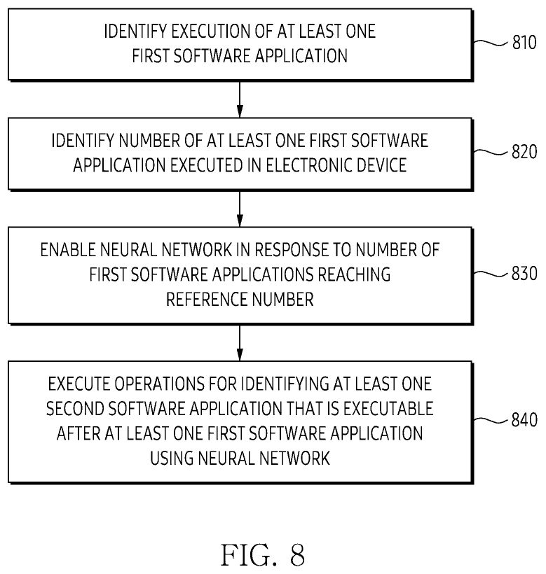

FIG. 8 illustrates an example of a flowchart indicating an operation of an electronic device according to an embodiment. The electronic device of FIG. 8 may include the electronic device 101 of FIGS. I to 7. At least one of operations of FIG. 8 may be performed by the electronic device 101 of FIG. 2 and/or the processor 210 of FIG. 2. Each of the operations of FIG. 8 may be performed sequentially, but is not necessarily performed sequentially. For example, an order of each of the operations may be changed, and at least two operations may be performed in parallel.

Referring to FIG. 8, in an operation 810, the processor according to an embodiment may identify execution of at least one first software application. For example, the processor may identify the execution of the at least one first software application after identifying an input indicating an enabled state on a display of the electronic device 101. A timing at which the execution of the at least one first software application is identified may be obtained.

Referring to FIG. 8, in an operation 820, the processor according to an embodiment may identify the number of the at least one first software application executed in the electronic device. The at least one first software application may include software applications that are executable using a launcher software application (e.g., a software application used to execute a plurality of software applications installed in the electronic device). For example, the at least one first software application may include a software application used for execution of at least a portion (e.g., a camera function and/or a memo function) that is usable in a locked state. The locked state may mean a state in which at least some of a plurality of functions of the electronic device 101 are disabled. The disabled state may include a state in which execution of at least some of the plurality of functions is not usable. An unlocked state may mean a state in which the plurality of functions of the electronic device 101 are enabled.

Referring to FIG. 8, in an operation 830, the processor according to an embodiment may enable a neural network in response to the number of first software applications reaching a reference number. The processor may obtain session information (e.g., the session information 275 of FIG. 2) including the at least one first software application executed in the electronic device. The processor may enable driving of the neural network in order to input the session information to the neural network. As an example, the processor may identify whether the neural network is enabled based on a state of the electronic device. The state of the electronic device may be identified based on whether it is in a low power state, whether it is in a high temperature state, and/or whether one or more cores included in the processor are in an overload state. For example, the neural network may be configured to be disabled prior to the number of the at least one first software application reaches the reference number in the unlocked state. The neural network may be configured to be disabled while the electronic device is in the locked state. The neural network may be configured to be disabled in a specified state (e.g., a Doze mode or a standby mode) in a case that the electronic device is not used for a certain time.

Referring to FIG. 8, in an operation 840, the processor according to an embodiment may execute operations for identifying at least one second software application that is executable after the at least one first software application using the neural network. For example, operations for the processor to identify the at least one second software application may include an operation of learning the neural network to identify the at least one second software application or using the neural network to infer the at least one second software application.

For example, the processor may provide the neural network (e.g., the neural network 255 of FIG. 2) with the session information including first data indicating the at least one first software application and second data indicating information on time. An operation of providing the neural network (e.g., the neural network 255 of FIG. 2) with the session information may include an operation of providing the neural network with a vector parameter by changing the session information to the vector parameter.

For example, the processor may perform an operation to train the neural network to identify the at least one second software application based on providing the neural network with the session information. The neural network may be trained to infer that the at least one second software application will be executed after the at least one first software application is executed. The processor may use the neural network training module (e.g., the neural network training module 253 of FIG. 2) to train the neural network.

For example, in response to the number of the first software applications reaching the reference number (e.g., 5), the processor may provide the neural network (e.g., the neural network 650 of FIG. 6) with the session information indicating the first data indicating the at least one first software application and time information identifying the number of the at least one first software applications reaching the reference number (e.g., 5). As an example, the time information may include a time corresponding to a software application executed last among the at least one first software application. However, it is not limited thereto.

For example, from the neural network, the processor may perform an operation of inferring to identify the at least one second software application based on the session information from the neural network.

For example, the processor may perform an operation of displaying a visual object to guide execution of the at least one second software application on the display. The visual object may be referred to the at least one first software application 120 of FIG. 1 and/or the at least one second software application 130 of FIG. 1. For example, the processor may display the visual object on the edge region 125 of FIG. 1 and/or the hotseat region 126 of FIG. 1. For example, the visual object may be displayed based on a format such as a pop-up window or a notification message. However, it is not limited thereto. For example, the processor may perform an operation of storing log information (e.g., the log information 280 of FIG. 2) indicating enabling of the neural network in memory. However, it is not limited thereto.

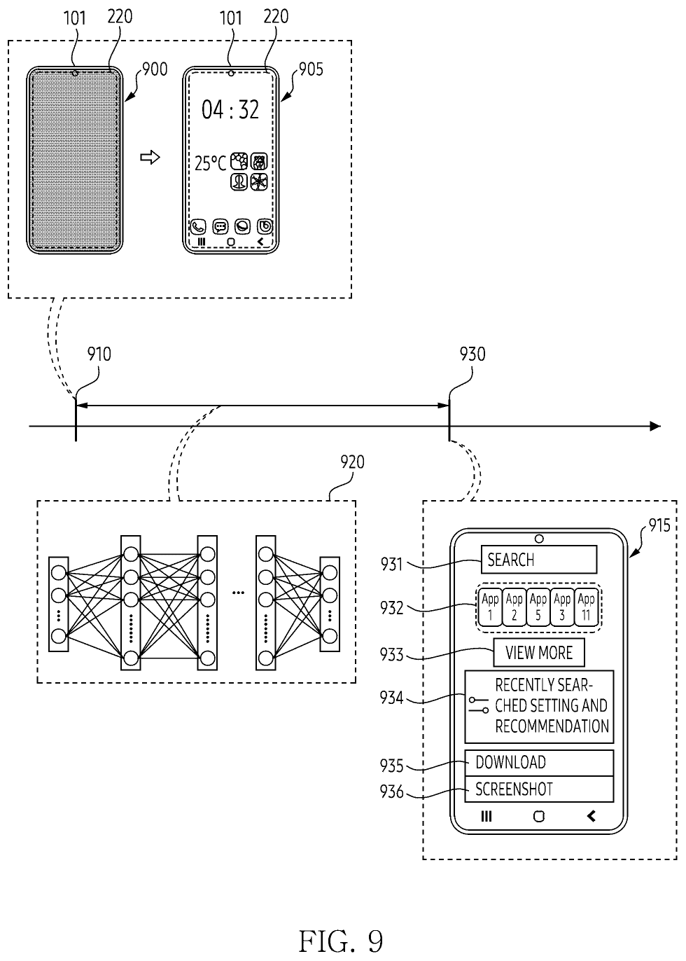

FIG. 9 illustrates an example of an operation in which an electronic device obtains log information indicating driving of a neural network according to an embodiment. An electronic device 101 of FIG. 9 may include the electronic device 101 of FIGS. 1 to 8. A processor 210 of FIG. 9 may be referred to the processor 210 of FIG. 2. A neural network 920 of FIG. 9 may be referenced to the neural network 255 of FIG. 2 and/or the neural network 650 of FIG. 6. In FIG. 9, operations performed by the electronic device 101 may be performed by the processor 210 of FIG. 2.

Referring to FIG. 9, the electronic device 101 according to an embodiment may identify an input indicating entry into an unlocked state 905 from a locked state 900. The lock state 900 may include a disabled state of a display 220. The lock state 900 may include a state in which at least one screen (e.g., an always on display screen) is displayed on the display 220 by a processor (e.g., a display driver IC (DDI)) related to the display 220. However, it is not limited thereto.

For example, the electronic device 101 may identify a timing 910 at which at least one software application initiates execution after entering the unlocked state 905. The electronic device 101 may identify the number of the at least one software application executed in the unlocked state 905.

For example, the electronic device 101 may enable the neural network 920 from a timing 910 to a timing 930. Based on enabling the neural network 920, the electronic device 101 may perform operations of training the neural network 920 or inferring through the neural network. However, it is not limited thereto.

For example, the electronic device 101 may perform the operations using the neural network using session information including information on software applications reaching the reference number, the timing 910, and/or the timing 930.

For example, in a case of training the neural network 920, the electronic device 101 may train to infer a software application to be executed after a second timing by using at least one software application executed from a first timing (e.g., the timing 910) at which execution of the at least one software application is initiated to the second timing (e.g., the timing 930) that identified the number (e.g., 4) of the at least one software application less than the reference number (e.g., 5).

For example, in a case of inferring at least one software application using the neural network 920, the electronic device 101 may identify a fourth timing (e.g., the timing 930) at which a software application executed last among at least one software application executed after a third timing (e.g., the timing 910) at which execution of at least one software application is initiated. The electronic device 101 may infer one or more software applications to be executed after the fourth timing using the trained neural network 920.

For example, the electronic device 101 may store log information indicating an enabled state of the neural network 920 in memory during a time period including the timing 910 and the timing 930. For example, the log information may include information indicating that the neural network 920 is enabled after the software applications corresponding to the reference number are executed and the neural network 920 is disabled based on reaching the timing 930. For example, the log information may include information on the software applications corresponding to the reference number and information on software applications 932 inferred based on the software applications corresponding to the reference number.

For example, in a state 915 for notifying the inferred software applications 932, the electronic device 101 may display a user interface (UI) on the display 220 to display the software applications 932 inferred through the neural network 920. The UI may include one or more visual objects 931, 932, 933, 934, 935, and 936.

For example, the visual object 931 may include a browse window for browsing at least one program installed in the electronic device 101. The visual object 933 may be used to receive a user input for further displaying the software applications 932. Based on receiving the input to the visual object 933, the electronic device 101 may further display, on the display 220, more software applications than the number (e.g., 5) of the software applications 932. The visual object 934 may include a text object indicating at least one program browsed using the visual object 931. The visual object 934 may include a text object related to the browsed at least one program.

For example, the electronic device 101 may display, on the display, another UI to display a list of programs installed in the electronic device 101 in response to an input indicating that the visual object 935 is selected. For example, the electronic device 101 may display, on the display, still another UI to display a list of images stored in the electronic device 101 in response to an input indicating that the visual object 936 is selected. However, it is not limited thereto.

As described above, the electronic device 101 may display a UI for guiding a user to execute software applications inferred through the neural network 920 on the display. The electronic device 101 may enhance user convenience based on displaying the UI on the display. The electronic device 101 may provide a notification message for indicating the enabled state of the neural network 920 to the user. For example, the electronic device 101 may provide the user with a notification message indicating that the neural network 920 performs a function for inference with respect to at least one software application, by obtaining the log information indicating enabling of the neural network 920.

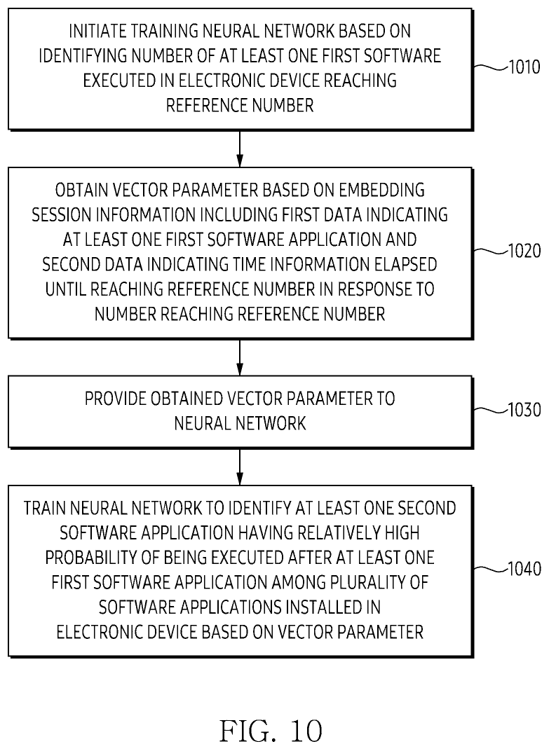

FIG. 10 illustrates an example of a flowchart indicating an operation of an electronic device according to an embodiment. The electronic device of FIG. 10 may include the electronic device 101 of FIGS. 1 to 9. At least one of operations of FIG. 10 may be performed by the electronic device 101 of FIG. 2 and/or the processor 210 of FIG. 2. Each of the operations of FIG. 10 may be performed sequentially, but is not necessarily performed sequentially. For example, an order of each of the operations may be changed, and at least two operations may be performed in parallel. At least one of the operations of FIG. 10 may be related to at least one of the operations of FIG. 8.

Referring to FIG. 10, in an operation 1010, the processor according to an embodiment may initiate training a neural network based on identifying the number of at least one first software executed in the electronic device using use history information 510. The reference number may be one or more.

Referring to FIG. 10, in an operation 1020, a vector parameter may be obtained based on embedding session information including first data indicating at least one first software application and second data indicating time information elapsed until reaching the reference number in response to the number of identified first software applications reaching the reference number. The time information elapsed until reaching the reference number may include a timing of identifying execution of a software application executed last among the at least one first software application.

The first data and/or the second data may be included in the session information 520 of FIG. 5. The processor may obtain label information by labeling the session information to provide the session information to the neural network (e.g., the neural network 255 of FIG. 2). The processor may change the label information into embedding information based on dimensions greater than or equal to one dimension to provide the session information to the neural network (e.g., the neural network 255 of FIG. 2).

Referring to FIG. 10, in an operation 1030, the processor according to an embodiment may provide the obtained vector parameter to the neural network. The vector parameter may be included in the embedding information based on the dimensions greater than or equal to one dimension. Referring to FIG. 10, in an operation 1040, the processor according to an embodiment may train the neural network to identify at least one second software application having a relatively high probability of being executed after the at least one first software application among a plurality of software applications installed in the electronic device based on the vector parameter. For example, the processor may train the neural network based on supervised learning. The processor may train the neural network to infer the at least one second software application to be executed after the at least one first software application, based on the session information including information on the at least one second software application. For example, the processor may identify an execution order of the at least one first software application. The processor may identify the at least one second software application to be executed after the at least one first software application is executed based on the execution order.

For example, the processor may obtain probability information for each of a plurality of software applications installed in memory to identify the at least one second software application based on the session information provided to the neural network. The processor may train the neural network to identify the at least one second software application having the relatively high probability of being executed after the at least one first software application among the plurality of software applications is executed, by using the probability information. The at least one second software application having the relatively high probability may be one or more. For example, the electronic device 101 may change the number of the second software applications having the relatively high probability.

For example, after training the neural network, the processor may tune the trained neural network using newly stored session information. Weights included in the tuned neural network may be different from weights included in the trained neural network. However, it is not limited thereto.

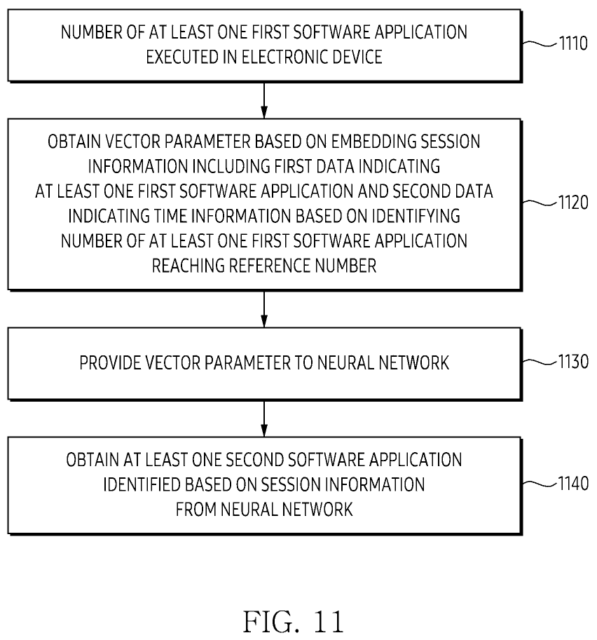

FIG. 11 illustrates an example of a flowchart indicating an operation of an electronic device according to an embodiment. The electronic device of FIG. 11 may include the electronic device 101 of FIGS. 1 to 10. At least one of operations of FIG. 11 may be performed by the electronic device 101 of FIG. 2 and/or the processor 210 of FIG. 2. Each of the operations of FIG. 11 may be performed sequentially, but is not necessarily performed sequentially. For example, an order of each of the operations may be changed, and at least two operations may be performed in parallel. At least one of the operations of FIG. 11 may be related to at least one of the operations of FIG. 8.

Referring to FIG. 11, in an operation 1110, the processor according to an embodiment may identify the number of at least one first software application executed in the electronic device. In an operation 1120, the processor according to an embodiment may obtain a vector parameter based on embedding session information including first data indicating the at least one first software application and second data indicating time information based on identifying the number of the at least one first software application reaching a reference number. The vector parameter may be included in the embedding information 273 of FIG. 2. The time information may include a timing at which execution of the at least one first software application is initiated, and a timing at which execution of a software application executed last among the at least one first software application is identified. In an operation 1130, the processor according to an embodiment may provide the vector parameter to a neural network (e.g., the neural network 650 of FIG. 6). For example, the session information may include the session data sets 275-1 to 275-n of FIG. 6.

Referring to FIG. 11, in an operation 1140, the processor according to an embodiment may obtain the at least one second software application identified based on the session information from the neural network. The at least one second software application may be an example of software applications that are executable after the at least one first software application that is executed.

For example, the processor may display, on a display, a visual object that guides execution of the at least one second software application. For example, the processor may display, on the display (e.g., the display 220 of FIG. 2), a visual object including an icon corresponding to the at least one second software application based on an order of the at least one second software application. The visual object may be referred to the at least one first software application 120 of FIG. 1, the second software applications 130 of FIG. 1, and/or the software application 932 of FIG. 9. The order of the at least one second software application may be identified based on probability information obtained through the neural network. For example, the processor may obtain probability information on the at least one second software application that is executable after the at least one first software application using the neural network. The probability information may be obtained based on an order in which a probability of being executed after the at least one first software application among a plurality of software applications installed in memory is relatively high. For example, the processor may display the visual object based on the order identified using the probability information.

For example, the processor may load data corresponding to the at least one second software application into a memory region prior to identifying an input indicating execution of the at least one second software application based on obtaining the at least one second software application. The processor may process execution of the at least one more quickly based on loading the data corresponding to the at least one into the memory region.

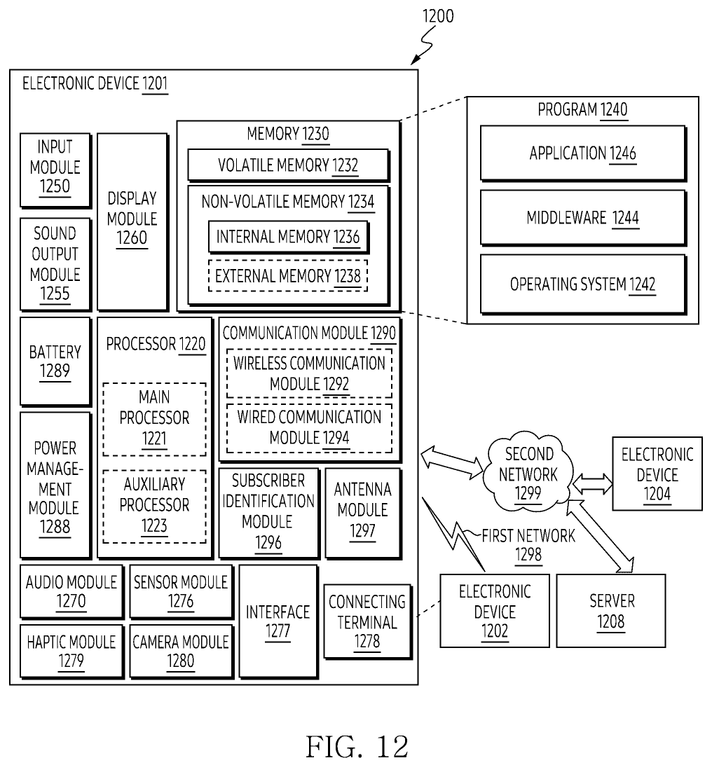

FIG. 12 is a block diagram illustrating an electronic device 1201 in a network environment 1200 according to various embodiments. Referring to FIG. 12, the electronic device 1201 in the network environment 1200 may communicate with an electronic device 1202 via a first network 1298 (e.g., a short-range wireless communication network), or at least one of an electronic device 1204 or a server 1208 via a second network 1299 (e.g., a long-range wireless communication network). According to an embodiment, the electronic device 1201 may communicate with the electronic device 1204 via the server 1208. According to an embodiment, the electronic device 1201 may include a processor 1220, memory 1230, an input module 1250, a sound output module 1255, a display module 1260, an audio module 1270, a sensor module 1276, an interface 1277, a connecting terminal 1278, a haptic module 1279, a camera module 1280, a power management module 1288, a battery 1289, a communication module 1290, a subscriber identification module (SIM) 1296, or an antenna module 1297. In some embodiments, at least one of the components (e.g., the connecting terminal 1278) may be omitted from the electronic device 1201, or one or more other components may be added in the electronic device 1201. In some embodiments, some of the components (e.g., the sensor module 1276, the camera module 1280, or the antenna module 1297) may be implemented as a single component (e.g., the display module 1260).

The processor 1220 may execute, for example, software (e.g., a program 1240) to control at least one other component (e.g., a hardware or software component) of the electronic device 1201 coupled with the processor 1220, and may perform various data processing or computation. According to an embodiment, as at least part of the data processing or computation, the processor 1220 may store a command or data received from another component (e.g., the sensor module 1276 or the communication module 1290) in volatile memory 1232, process the command or the data stored in the volatile memory 1232, and store resulting data in non-volatile memory 1234. According to an embodiment, the processor 1220 may include a main processor 1221 (e.g., a central processing unit (CPU) or an application processor (AP)), or an auxiliary processor 1223 (e.g., a graphics processing unit (GPU), a neural processing unit (NPU), an image signal processor (ISP), a sensor hub processor, or a communication processor (CP)) that is operable independently from, or in conjunction with, the main processor 1221. For example, when the electronic device 1201 includes the main processor 1221 and the auxiliary processor 1223, the auxiliary processor 1223 may be adapted to consume less power than the main processor 1221, or to be specific to a specified function. The auxiliary processor 1223 may be implemented as separate from, or as part of the main processor 1221.

The auxiliary processor 1223 may control at least some of functions or states related to at least one component (e.g., the display module 1260, the sensor module 1276, or the communication module 1290) among the components of the electronic device 1201, instead of the main processor 1221 while the main processor 1221 is in an inactive (e.g., sleep) state, or together with the main processor 1221 while the main processor 1221 is in an active state (e.g., executing an application). According to an embodiment, the auxiliary processor 1223 (e.g., an image signal processor or a communication processor) may be implemented as part of another component (e.g., the camera module 1280 or the communication module 1290) functionally related to the auxiliary processor 1223. According to an embodiment, the auxiliary processor 1223 (e.g., the neural processing unit) may include a hardware structure specified for artificial intelligence model processing. An artificial intelligence model may be generated by machine learning. Such learning may be performed, e.g., by the electronic device 1201 where the artificial intelligence is performed or via a separate server (e.g., the server 1208). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1230 may store various data used by at least one component (e.g., the processor 1220 or the sensor module 1276) of the electronic device 1201. The various data may include, for example, software (e.g., the program 1240) and input data or output data for a command related thereto. The memory 1230 may include the volatile memory 1232 or the non- volatile memory 1234.

The program 1240 may be stored in the memory 1230 as software, and may include, for example, an operating system (OS) 1242, middleware 1244, or an application 1246.

The input module 1250 may receive a command or data to be used by another component (e.g., the processor 1220) of the electronic device 1201, from the outside (e.g., a user) of the electronic device 1201. The input module 1250 may include, for example, a microphone, a mouse, a keyboard, a key (e.g., a button), or a digital pen (e.g., a stylus pen).

The sound output module 1255 may output sound signals to the outside of the electronic device 1201. The sound output module 1255 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1260 may visually provide information to the outside (e.g., a user) of the electronic device 1201. The display module 1260 may include, for example, a display, a hologram device, or a projector and control circuitry to control a corresponding one of the display, hologram device, and projector. According to an embodiment, the display module 1260 may include a touch sensor adapted to detect a touch, or a pressure sensor adapted to measure the intensity of force incurred by the touch.

The audio module 1270 may convert a sound into an electrical signal and vice versa. According to an embodiment, the audio module 1270 may obtain the sound via the input module 1250, or output the sound via the sound output module 1255 or a headphone of an external electronic device (e.g., an electronic device 1202) directly (e.g., wiredly) or wirelessly coupled with the electronic device 1201.

The sensor module 1276 may detect an operational state (e.g., power or temperature) of the electronic device 1201 or an environmental state (e.g., a state of a user) external to the electronic device 1201, and then generate an electrical signal or data value corresponding to the detected state. According to an embodiment, the sensor module 1276 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1277 may support one or more specified protocols to be used for the electronic device 1201 to be coupled with the external electronic device (e.g., the electronic device 1202) directly (e.g., wiredly) or wirelessly. According to an embodiment, the interface 1277 may include, for example, a high definition multimedia interface (HDMI), a universal serial bus (USB) interface, a secure digital (SD) card interface, or an audio interface.

A connecting terminal 1278 may include a connector via which the electronic device 1201 may be physically connected with the external electronic device (e.g., the electronic device 1202). According to an embodiment, the connecting terminal 1278 may include, for example, an HDMI connector, a USB connector, an SD card connector, or an audio connector (e.g., a headphone connector).

The haptic module 1279 may convert an electrical signal into a mechanical stimulus (e.g., a vibration or a movement) or electrical stimulus which may be recognized by a user via his tactile sensation or kinesthetic sensation. According to an embodiment, the haptic module 1279 may include, for example, a motor, a piezoelectric element, or an electric stimulator.

The camera module 1280 may capture a still image or moving images. According to an embodiment, the camera module 1280 may include one or more lenses, image sensors, image signal processors, or flashes.

The power management module 1288 may manage power supplied to the electronic device 1201. According to an embodiment, the power management module 1288 may be implemented as at least part of, for example, a power management integrated circuit (PMIC).

The battery 1289 may supply power to at least one component of the electronic device 1201. According to an embodiment, the battery 1289 may include, for example, a primary cell which is not rechargeable, a secondary cell which is rechargeable, or a fuel cell.

The communication module 1290 may support establishing a direct (e.g., wired) communication channel or a wireless communication channel between the electronic device 1201 and the external electronic device (e.g., the electronic device 1202, the electronic device 1204, or the server 1208) and performing communication via the established communication channel. The communication module 1290 may include one or more communication processors that are operable independently from the processor 1220 (e.g., the application processor (AP)) and supports a direct (e.g., wired) communication or a wireless communication. According to an embodiment, the communication module 1290 may include a wireless communication module 1292 (e.g., a cellular communication module, a short-range wireless communication module, or a global navigation satellite system (GNSS) communication module) or a wired communication module 1294 (e.g., a local area network (LAN) communication module or a power line communication (PLC) module). A corresponding one of these communication modules may communicate with the external electronic device via the first network 1298 (e.g., a short-range communication network, such as Bluetooth™, wireless-fidelity (Wi-Fi) direct, or infrared data association (IrDA)) or the second network 1299 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1292 may identify and authenticate the electronic device 1201 in a communication network, such as the first network 1298 or the second network 1299, using subscriber information (e.g., international mobile subscriber identity (IMSI)) stored in the subscriber identification module 1296.

The wireless communication module 1292 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1292 may support a high-frequency band (e.g., the mm Wave band) to achieve, e.g., a high data transmission rate. The wireless communication module 1292 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1292 may support various requirements specified in the electronic device 1201, an external electronic device (e.g., the electronic device 1204), or a network system (e.g., the second network 1299). According to an embodiment, the wireless communication module 1292 may support a peak data rate (e.g., 20Gbps or more) for implementing eMBB, loss coverage (e.g., 1264 dB or less) for implementing mMTC, or U-plane latency (e.g., 0.5 ms or less for each of downlink (DL) and uplink (UL), or a round trip of 12 ms or less) for implementing URLLC.

The antenna module 1297 may transmit or receive a signal or power to or from the outside (e.g., the external electronic device) of the electronic device 1201. According to an embodiment, the antenna module 1297 may include an antenna including a radiating element composed of a conductive material or a conductive pattern formed in or on a substrate (e.g., a printed circuit board (PCB)). According to an embodiment, the antenna module 1297 may include a plurality of antennas (e.g., array antennas). In such a case, at least one antenna appropriate for a communication scheme used in the communication network, such as the first network 1298 or the second network 1299, may be selected, for example, by the communication module 1290 (e.g., the wireless communication module 1292) from the plurality of antennas. The signal or the power may then be transmitted or received between the communication module 1290 and the external electronic device via the selected at least one antenna. According to an embodiment, another component (e.g., a radio frequency integrated circuit (RFIC)) other than the radiating element may be additionally formed as part of the antenna module 1297.

According to various embodiments, the antenna module 1297 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1201 and the external electronic device 1204 via the server 1208 coupled with the second network 1299. Each of the electronic devices 1202 or 1204 may be a device of a same type as, or a different type, from the electronic device 1201. According to an embodiment, all or some of operations to be executed at the electronic device 1201 may be executed at one or more of the external electronic devices 1202, 1204, or 1208. For example, if the electronic device 1201 should perform a function or a service automatically, or in response to a request from a user or another device, the electronic device 1201, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1201. The electronic device 1201 may provide the outcome, with or without further processing of the outcome, as at least part of a reply to the request. To that end, a cloud computing, distributed computing, mobile edge computing (MEC), or client-server computing technology may be used, for example. The electronic device 1201 may provide ultra low-latency services using, e.g., distributed computing or mobile edge computing. In another embodiment, the external electronic device 1204 may include an internet-of-things (IoT) device. The server 1208 may be an intelligent server using machine learning and/or a neural network. According to an embodiment, the external electronic device 1204 or the server 1208 may be included in the second network 1299. The electronic device 1201 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via at least a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC). Thus, each “module” herein may comprise circuitry.

Various embodiments as set forth herein may be implemented as software (e.g., the program 1240) including one or more instructions that are stored in a storage medium (e.g., internal memory 1236 or external memory 1238) that is readable by a machine (e.g., the electronic device 1201). For example, a processor (e.g., the processor 1220) of the machine (e.g., the electronic device 1201) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added. The electronic device 1201 of FIG. 12 may be referred to the electronic device 101 of FIG. 1. The processor 1220 of FIG. 12 may be referred to the processor 210 of FIG. 2.

An electronic device according to an embodiment may infer a second software application to be executed after first software applications are executed using the first software applications executed for a specified time period using a neural network. A method in which the electronic device uses the neural network to infer the second software application may be required.

As described above, in a non-transitory computer-readable storage medium storing one or more programs, the one or more programs, when executed by at least one processor 120 of an electronic device 101, may be configured to identify that the electronic device enters an unlocked state 905. The one or more programs, when executed by the at least one processor of the electronic device, may be configured to, prior to a change of the entered unlocked state to a locked state 900, identify a number of first software applications executed within the electronic device. The one or more programs, when executed by the at least one processor of the electronic device, may be configured to, in response to the number reaching a reference number prior to a change of the unlocked state to the locked state, provide a trained neural network 255 or 650 with session information 110, 275, 520, or 610 including first data indicating each of the first software applications and second data indicating a timing of entry into the unlocked state. The one or more programs, when executed by the at least one processor of the electronic device, may be configured to obtain second software applications 710 identified based on the session information from the trained neural network. The one or more programs may be configured to comprise instructions that, when executed by the at least one processor of the electronic device, cause the electronic device to display, on a display 220, a visual object 120 or 130 guiding execution of the second software applications.

For example, in order to obtain the second software applications, the one or more programs may be configured to comprise instructions that, when executed by the at least one processor of the electronic device, cause the electronic device to, based on the session information, obtain the second software applications that are executable after the first software applications.

For example, in order to display the visual object, the one or more programs may be configured to comprise instructions that, when executed by the at least one processor of the electronic device, cause the electronic device to, based on an order of the second software applications, display the visual object including icons corresponding to each of the second software applications.

For example, in order to display the visual object, the one or more programs, when executed by the at least one processor of the electronic device, may obtain probability information for each of the second software applications that are executable after the first software applications using the trained neural network. The one or more programs may be configured to comprise instructions that, when executed by the at least one processor of the electronic device, cause the electronic device to display the visual object based on the order identified using the probability information.

For example, in order to display the visual object, the one or more programs, when executed by the at least one processor of the electronic device, may be configured to, based on obtaining the second software applications, prior to identifying an input indicating execution of at least one of the second software applications, load, into a memory region, third data corresponding to the at least one. The one or more programs, when executed by the at least one processor of the electronic device, may be configured to display the visual object guiding execution of the at least one.

For example, the neural network may be configured to be trained to identify a fourth software application corresponding to the reference number, using third software applications executed prior to reaching the reference number. The one or more programs may be configured to comprise instructions that, when executed by the at least one processor of the electronic device, cause the electronic device to store other session information indicating the third software applications and the fourth software application in memory 215.

For example, in order to obtain the second software applications, the one or more programs may be configured to comprise instructions that, when executed by the at least one processor of the electronic device, cause the electronic device to, based on identifying the session information, obtain the second software applications, using the other session information corresponding to the session information.

For example, the first software applications may correspond to the third software applications. The second software applications may include the fourth software application.

As described above, in a method performed by an electronic device 101, the method may comprise identifying that the electronic device enters an unlocked state 905. The method may comprise, prior to a change of the entered unlocked state to a locked state 900, identifying a number of first software applications executed within the electronic device. The method may comprise, in response to the number reaching a reference number prior to a change of the unlocked state to the locked state, providing a trained neural network 255 or 650 with session information 110, 275, 520, or 610 including first data indicating each of the first software applications, second data indicating a timing of entry into the unlocked state, and third data indicating a timing of change to the locked state. The method may comprise training the neural network to identify a second software application that is executable after the first software applications.

For example, training the neural network may comprise identifying an execution order of the first software applications. For example, training the neural network may comprise identifying the second software application executed last based on the execution order. In training the neural network, the second software application executed at the last may correspond to the reference number.

For example, providing it to the neural network may comprise providing the neural network with the session information including the first data, the second data, and the third data obtained based on embedding each of the first software applications, the timing of entry into the unlocked state, and the timing of change to the locked state. In providing it to the neural network, each of the first data, the second data, and the third data may include a vector parameter based on based on six dimensions 540.

For example, training the neural network may comprise obtaining probability information for each of the plurality of software applications installed in memory, to identify the second software application based on the session information provided to the neural network. Training the neural network may comprise training the neural network to identify the second software application having the highest probability of being executed after the first software applications from among the plurality of software applications using the probability information.

For example, the electronic device may be configured to include a display 220. The method may further comprise displaying, on the display, a visual object guiding execution of the second software application, by inputting the session information to the neural network for which the training is completed.

For example, displaying the visual object may comprise loading fourth data corresponding to the second software application into memory.

For example, providing the session information to the neural network may comprise, in response to the number reaching a reference number, activating the neural network, based on identifying entry into the unlocked state. Providing the session information to the neural network may comprise providing the session information to the activated neural network.

As described above, in a non-transitory computer-readable storage medium storing one or more programs, the one or more programs, when executed by at least one processor 120 of an electronic device 101, may identify that the electronic device enters an unlocked state 905. The one or more programs, when executed by the at least one processor of the electronic device, may be configured to, prior to a change of the entered unlocked state to a locked state 900, identify a number of first software applications executed within the electronic device. The one or more programs, when executed by the at least one processor of the electronic device, may activate a trained neural network 255 or 650, in response to the number reaching a reference number. The one or more programs may be configured to comprise instructions that, when executed by the at least one processor of the electronic device, cause the electronic device to execute operations for identifying a second software application that is executable after the first software applications. The neural network may be deactivated prior to the number reaches the reference number in the unlocked state. The neural network may be deactivated while the electronic device is in the locked state.

For example, in order to execute the operations for identifying the second software application, the one or more programs, when executed by the at least one processor of the electronic device, may be configured to provide a trained neural network 255 or 650 with session information 110, 275, 520, or 610 including first data indicating each of the first software applications, second data indicating a timing of entry into the unlocked state, and third data indicating a timing of change to the locked state. The one or more programs may be configured to comprise instructions that, when executed by the at least one processor of the electronic device, cause the electronic device to execute the operations for training the neural network to identify the second software application, based on providing it to the neural network.

For example, in order to execute the operations for identifying the second software application, the one or more programs, when executed by the at least one processor of the electronic device, may be configured to, in response to the number reaching the reference number prior to a change of the unlocked state to the locked state, provide the trained neural network with other session information including first data indicating each of the first software applications and second data indicating the timing of entry into the unlocked state. The one or more programs may be configured to comprise instructions that, when executed by the at least one processor of the electronic device, cause the electronic device to execute, from the trained neural network, the operations for identifying the second software application based on the other session information.

For example, in order to execute the operations for identifying the second software application, the one or more programs may be configured to comprise instructions that, when executed by the at least one processor of the electronic device, cause the electronic device to execute the operations of displaying, on a display 220, a visual object 120 or 130 for guiding execution of the second software application.

For example, the one or more programs may be configured to comprise instructions that, when executed by the at least one processor of the electronic device, cause the electronic device to store log information 580 indicating activation of the neural network in memory 215.

As described above, in an electronic device according to an embodiment, the electronic device may include a display, memory, and a processor. The processor may be configured to identify that the electronic device enters an unlocked state. The processor may be configured to, prior to a change of the entered unlocked state to a locked state, identify a number of first software applications executed within the electronic device. The processor may be configured to, in response to the number reaching a reference number prior to a change of the unlocked state to the locked state, provide a trained neural network with session information including first data indicating each of the first software applications and second data indicating a timing of entry into the unlocked state. The processor may be configured to obtain second software applications 710 identified based on the session information from the trained neural network. The processor may be configured to display, on the display, a visual object guiding execution of the second software applications.

For example, in order to obtain the second software applications, the processor may be configured to, based on the session information, obtain the second software applications that are executable after the first software applications.

For example, in order to display the visual object, the processor may be configured to, based on an order of the second software applications, display the visual object including icons corresponding to each of the second software applications.

For example, in order to display the visual object, the processor may be configured to obtain probability information for each of the second software applications that are executable after the first software applications using the trained neural network. The processor may be configured to display the visual object based on the order identified using the probability information.

For example, in order to display the visual object, the processor may, based on obtaining the second software applications, prior to identifying an input indicating execution of at least one of the second software applications, load, into a memory region, third data corresponding to the at least one. The processor may be configured to display the visual object guiding execution of the at least one.

For example, the neural network may be trained to identify a fourth software application corresponding to the reference number, using third software applications executed prior to reaching the reference number. The processor may be configured to store other session information indicating the third software applications and the fourth software application in the memory.

For example, in order to obtain the second software applications, the processor may be configured to, based on identifying the session information, obtain the second software applications, using the other session information corresponding to the session information.

For example, the first software applications may correspond to the third software applications. The second software applications may include the fourth software application.

As described above, in an electronic device according to an embodiment, the electronic device may comprise memory, and a processor. The processor may be configured to identify that the electronic device enters an unlocked state. The processor may be configured to, prior to a change of the entered unlocked state to a locked state, identify a number of first software applications executed within the electronic device. The processor may be configured to activate a trained neural network, in response to the number reaching a reference number. The processor may be configured to execute operations for identifying a second software application that is executable after the first software applications. The neural network may be deactivated prior to the number reaches the reference number in the unlocked state. The neural network may be deactivated while the electronic device is in the locked state.

For example, in order to execute the operations for identifying the second software application, the processor may be configured to provide a trained neural network with session information including first data indicating each of the first software applications, second data indicating a timing of entry into the unlocked state, and third data indicating a timing of change to the locked state. The processor may be configured to execute the operations for training the neural network to identify the second software application, based on providing it to the neural network.

For example, in order to execute the operations for identifying the second software application, the processor may be configured to, in response to the number reaching the reference number prior to a change of the unlocked state to the locked state, provide the trained neural network with other session information including first data indicating each of the first software applications and second data indicating the timing of entry into the unlocked state. The processor may be configured to execute, from the trained neural network, the operations for identifying the second software application based on the other session information.

For example, the electronic device may further include a display. In order to execute the operations for identifying the second software application, the processor may be configured to execute the operations of displaying, on the display, a visual object for guiding execution of the second software application.

For example, the processor may be configured to store log information indicating activation of the neural network in the memory.

As described above, in a non-transitory computer-readable storage medium storing one or more programs, the one or more programs, when executed by at least one processor 120 of an electronic device 101, may be configured to identify a number of at least one first software application executed in the electronic device. The one or more programs, when executed by the at least one processor of the electronic device, may be configured to, in response to the number reaching a reference number, obtain a vector parameter based on embedding session information 110, 275, 520, or 610 including first data indicating the at least one first software application and second data indicating time information. The one or more programs, when executed by the at least one processor of the electronic device, may be configured to provide the obtained vector parameter to a neural network 255 or 650. The one or more programs, when executed by the at least one processor of the electronic device, may be configured to obtain at least one second software application 710 identified based on the session information from the neural network.

For example, in order to obtain the at least one second software application, the one or more programs may be configured to comprise instructions that, when executed by the at least one processor of the electronic device, cause the electronic device to, based on the session information, obtain the at least one second software application that is executable after the at least one first software application.

For example, the one or more programs, when executed by the at least one processor of the electronic device, may be configured to display, on a display 220, a visual object 120 or 130 related to the at least one second software application. The one or more programs may be configured to comprise instructions that, when executed by the at least one processor of the electronic device, cause the electronic device to, based on an order of the at least one second software application, display the visual object including icons corresponding to the at least one second software application.

For example, the one or more programs may be configured to comprise instructions that, when executed by the at least one processor of the electronic device, cause the electronic device to display the visual object based on the order identified using probability information for each of the at least one second software application.

For example, the one or more programs, when executed by the at least one processor of the electronic device, may be configured to, based on obtaining the at least one second software application, prior to identifying an input indicating execution of the at least one second software application, load, into a memory region, third data corresponding to the at least one second software application. The one or more programs may be configured to comprise instructions that, when executed by the at least one processor of the electronic device, cause the electronic device to display the visual object guiding execution of the at least one second software application.

For example, in order to identify the number of the at least one first software application, the one or more programs, when executed by the at least one processor of the electronic device, may be configured to identify that the electronic device enters an unlocked state 905. The one or more programs may be configured to comprise instructions that, when executed by the at least one processor of the electronic device, cause the electronic device to, prior to a change of the entered unlocked state to a locked state 900, identify the number of the at least one first software application executed within the electronic device.

For example, the one or more programs, when executed by the at least one processor of the electronic device, may be configured to obtain label information including numbers corresponding respectively to words using the session information including the words. The one or more programs may be configured to comprise instructions that, when executed by the at least one processor of the electronic device, cause the electronic device to obtain the at least one second software application based on obtaining the vector parameter by embedding the label information.

For example, the one or more programs may be configured to comprise instructions that, cause the electronic device to obtain the probability information for each of the at least one second software application that is executable after the at least one first software application using the neural network.

In a method performed by an electronic device 101 according to an embodiment, the method may comprise initiating training of a neural network 255 or 650 based on identifying a number of at least one first software application executed within the electronic device reaching a reference number. The method may comprise obtaining a vector parameter based on embedding session information 110, 275, 520 or 610 including first data indicating the at least one first software application and second data indicating time information. The method may comprise providing the obtained vector parameter to the neural network. The method may comprise training the neural network to identify at least one second software application having a relatively high probability of being executed after the at least one first software application from among a plurality of software applications installed in the electronic device based on the vector parameter.

For example, training the neural network may comprise identifying an execution order of the at least one first software application. Training the neural network may comprise identifying the at least one second software application executed last based on the execution order. In training the neural network, the at least one second software application executed at the last may correspond to the reference number.

For example, providing it to the neural network may comprise providing the vector parameter based on six dimensions 540, obtained based on embedding the at least one first software application and the time information, to the neural network.

For example, training the neural network may comprise training the neural network to obtain probability information for each of the plurality of software applications installed in memory, to identify the at least one second software application based on the session information provided to the neural network.

For example, the electronic device may include a display 220. The method may comprise identifying that training of the neural network is complete or ongoing. The method may comprise displaying, on the display, a notification message indicating information related to the training of the neural network is complete or ongoing.

For example, the method may comprise loading fourth data corresponding to the at least one second software application into memory.

For example, the method may comprise, in response to the number reaching a reference number, activating the neural network, based on identifying entry into the unlocked state. The method may comprise providing the session information to the activated neural network.

As described above, in a method performed by an electronic device 101, the method may comprise identifying a number of at least one first software application executed in the electronic device. The method may comprise, in response to the number reaching a reference number, obtaining a vector parameter based on embedding session information 110, 275, 520, or 610 including first data indicating each of the at least one first software application and second data indicating time information. The method may comprise providing the obtained vector parameter to a neural network 255 or 650. The method may comprise obtaining at least one second software application 710 identified based on the session information from the neural network.

For example, obtaining the at least one second software application may comprise based on the session information, obtaining the at least one second software application that is executable after the at least one first software application.

For example, the method may comprise displaying, on a display 220, a visual object 120 or 130 related to the at least one second software application. The method may comprise, based on an order of the at least one second software application, displaying the visual object including icons corresponding to the at least one second software application.

For example, the method may comprise displaying the visual object based on the order identified using probability information for each of the at least one second software application.

For example, the method may comprise storing log information 580 indicating activation of the neural network in memory 215.

As described above, an electronic device 101 according to an embodiment may comprise at least one processor 120 including processing circuitry and memory 130 including one or more storage media storing instructions. The instructions, when executed by the at least one processor, individually or collectively, may cause the electronic device 101 to identify a number of at least one first software application executed in the electronic device. The instructions, when executed by the at least one processor, individually or collectively, may cause the electronic device 101 to, in response to the number reaching a reference number, obtain a vector parameter based on embedding session information 110, 275, 520, or 610 including first data indicating the at least one first software application and second data indicating time information. The instructions, when executed by the at least one processor, individually or collectively, may cause the electronic device 101 to provide the obtained vector parameter to a neural network 255 or 650. The instructions, when executed by the at least one processor, individually or collectively, may cause the electronic device 101 to obtain at least one second software application 710 identified based on the session information from the neural network. “Based on” as used herein covers based at least on.

The device described above may be implemented as a hardware component, a software component, and/or a combination of a hardware component and a software component. For example, the devices and components described in the embodiments may be implemented by using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to the embodiment may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include a magnetic medium such as a hard disk, floppy disk, and magnetic tape, optical recording medium such as a CD-ROM and DVD, magneto-optical medium, such as a floptical disk, and those configured to store program instructions, including ROM, RAM, flash memory, and the like. In addition, examples of other media may include recording media or storage media managed by app stores that distribute applications, sites that supply or distribute various software, servers, and the like.

Although the embodiments have been described above with reference to limited examples and drawings, various modifications and variations may be made from the above description by those skilled in the art. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

Therefore, other implementations, other embodiments, and those equivalent to the scope of the claims are in the scope of the claims described later.

What is claimed is:

1. A non-transitory computer-readable storage medium storing one or more programs including instructions that are configured to, when executed by at least one processor of an electronic device individually or collectively, cause the electronic device to perform at least:
identify a number of at least one first software application executed in the electronic device;
in response to the number reaching a reference number, obtain a vector parameter based on embedding session information including first data indicating the at least one first software application and second data indicating time information;
provide the obtained vector parameter to a neural network; and
obtain at least one second software application, from the neural network, identified based on the session information.

2. The non-transitory computer-readable storage medium of claim 1,
wherein the instructions, when executed by the at least one processor of the electronic device, individually or collectively, cause the electronic device to:
based on the session information, obtain the at least one second software application that is executable after the at least one first software application.

3. The non-transitory computer-readable storage medium of claim 1,
wherein the instructions, when executed by the at least one processor of the electronic device, individually or collectively, cause the electronic device to:
display, on a display, a visual object related to the at least one second software application; and
based on an order of the at least one second software application, display the visual object including icons corresponding to the at least one second software application.

4. The non-transitory computer-readable storage medium of claim 3,
wherein the instructions, when executed by the at least one processor of the electronic device, individually or collectively, cause the electronic device to:
display the visual object based on the order identified based on probability information for each of the at least one second software application.

5. The non-transitory computer-readable storage medium of claim 1,
wherein the instructions, when executed by the at least one processor of the electronic device, individually or collectively, cause the electronic device to:
based on obtaining the at least one second software application, prior to identifying an input indicating execution of the at least one second software application, load, into a memory region, third data corresponding to the at least one second software application; and
display the visual object guiding execution of the at least one second software application.

6. The non-transitory computer-readable storage medium of claim 1,
wherein the instructions, when executed by the at least one processor of the electronic device, individually or collectively, cause the electronic device to:
identify entry into an unlocked state; and
prior to a change of the entered unlocked state to a locked state, identify the number of the at least one first software application executed within the electronic device.

7. The non-transitory computer-readable storage medium of claim 1,
wherein the instructions, when executed by the at least one processor of the electronic device, individually or collectively, cause the electronic device to:
obtain label information including numbers corresponding respectively to words based on the session information including the words; and
obtain the at least one second software application based on obtaining the vector parameter at least by embedding the label information.

8. The non-transitory computer-readable storage medium of claim 1,
wherein the instructions, when executed by the at least one processor of the electronic device, individually or collectively, cause the electronic device to:
obtain the probability information for each of the at least one second software application that is executable after the at least one first software application using the neural network.

9. A method performed by an electronic device, the method comprising:
initiating training of a neural network based on identifying a number of at least one first software application executed within the electronic device reaching a reference number;
obtaining a vector parameter based on embedding session information including first data indicating the at least one first software application and second data indicating time information;
providing the obtained vector parameter to the neural network; and
training the neural network to identify at least one second software application having a relatively high probability of being executed after the at least one first software application from among a plurality of software applications installed in the electronic device based on the vector parameter.

10. The method of claim 9, wherein training the neural network comprises:
identifying an execution order of the at least one first software application; and
identifying the at least one second software application executed last based on the execution order, and
wherein the at least one second software application executed at the last corresponds to the reference number.

11. The method of claim 9, wherein providing the vector parameter to the neural network comprises
providing the vector parameter based on a six-dimension, obtained based on embedding the at least one first software application and the time information, to the neural network.

12. The method of any of claims 9, wherein training the neural network comprises
training the neural network to obtain probability information for each of the plurality of software applications installed in memory, to identify the at least one second software application based on the session information provided to the neural network.

13. The method of claim 12,
wherein the electronic device includes a display, and
wherein the method comprises:
identifying that training of the neural network is complete or ongoing; and
displaying, on the display, a notification message indicating information related to the training of the neural network is complete or ongoing.

14. The method of claim 9, further comprising:
loading fourth data corresponding to the at least one second software application into memory.

15. An electronic device comprising:
at least one processor, including processing circuitry; and
memory including one or more storage media storing instructions that, when executed by the at least one processor individually or collectively, cause the electronic device to:
identify a number of at least one first software application executed in the electronic device;
in response to the number reaching a reference number, obtain a vector parameter based on embedding session information including first data indicating the at least one first software application and second data indicating time information;
provide the obtained vector parameter to a neural network; and
obtain at least one second software application identified based on the session information from the neural network.

16. The electronic device of claim 15, wherein the instructions, when executed by the at least one processor, individually or collectively, cause the electronic device to:
based on the session information, obtain the at least one second software application that is executable after the at least one first software application.

17. The electronic device of claim 15, wherein the instructions, when executed by the at least one processor, individually or collectively, cause the electronic device to:
display, on a display, a visual object related to the at least one second software application; and
based on an order of the at least one second software application, display the visual object including icons corresponding to the at least one second software application.

18. The electronic device of claim 17, wherein the instructions are configured to comprise instructions that, when executed by the at least one processor, individually or collectively, cause the electronic device to:
display the visual object based on the order identified using probability information for each of the at least one second software application.

19. The electronic device of claim 15, wherein the instructions, when executed by the at least one processor, individually or collectively, cause the electronic device to:
based on obtaining the at least one second software application, prior to identifying an input indicating execution of the at least one second software application, load, into a memory region, third data corresponding to the at least one second software application; and
display the visual object guiding execution of the at least one second software application.

20. The electronic device of claim 15, wherein the instructions, when executed by the at least one processor. individually or collectively, cause the electronic device to:
identify entry into an unlocked state; and
prior to a change of the entered unlocked state to a locked state, identify the number of the at least one first software application executed within the electronic device.
